(19) United States
(12) Patent Application Publication
(10) Pub. No.: US 2025/0111214 A1
(43) Pub. Date: Apr. 3, 2025

(54) METHOD AND SYSTEM FOR IN-LINE DATA CONVERSION AND DATA MANIPULATION

(71) Applicant: Marvell Asia Pte Ltd, Singapore (SG)

(72) Inventors: Ulf Hanebutte, Gig harbor, WA (US); Senad Durakovic, Palo Alto, CA (US); Harri Hakkarainen, Los Gatos, CA (US); Derek Chickles, San Jose, CA (US); Shivah Shankar Narayan Rao, Bangalore (IN)

(21) Appl. No.: 18/384,803

(22) Filed: Oct. 27, 2023

Related U.S. Application Data
(60) Provisional application No. 63/541,750, filed on Sep. 29, 2023.

(51) Int. Cl. G06N 3/063

(52) U.S. Cl. CPC G06N 3/063

(57) ABSTRACT

A machine learning (ML) hardware includes a first data format conversion block configured to receive data generated by an application source in a first data format. The first data format conversion block is configured to convert the received data from the first data format into a second data format. The first data format is different from the second data format. The ML hardware includes a plurality of processing units configured to perform one or more ML operations on the data in the second data format to generate a processed data. The ML hardware includes a second data format conversion block configured to convert the processed data to a third data format. The ML hardware further includes a transmitting component configured to output the processed data in the third data format to a memory component for use by an application destination.

### RELATED APPLICATION

This application is a nonprovisional application and claims the benefit and priority to a provisional application No. 63/541,750 filed on Sep. 29, 2023, which is incorporated herein by reference in its entirety.

### BACKGROUND

Use and implementations of machine learning (ML) and artificial intelligence (AI) methods on electronic devices has become ubiquitous. A hardware component of the electronic devices, whether a processor, a programmable logic, a dedicated hardware such as application specific integrated circuit (ASIC), or a dedicated ML hardware, often receives data in a different data format than the application that generates the data. For example, data may be generated by an application in floating point 32 whereas the hardware architecture designed for performing ML operations may require the data in a different data format (i.e., precision) such as floating point 16. Converting the data format from one data format to another data format is typically performed by a software component, e.g., a driver. Data conversion using software typically requires for the data to be read from a memory component that stores the data in its original data format, e.g., floating point 32, and subsequently for the data to be converted into the required data format, e.g., floating point 16, to form the newly converted data that is then stored in memory before the converted data is sent to the ML hardware for processing. Reading from a memory component first, converting the data into a different data format, and storing the newly converted data format for the data in a memory component before sending it to the ML hardware for processing can be inefficient and resource intensive since such process requires an additional write into a memory component.

Furthermore, electronic devices have become more complex and may include multiple memory systems, as an example. As one nonlimiting example, a dedicated ML hardware may include multiple memory systems and data such as tensor data may be represented by different precisions, orientation, or split across distributed blocks based on the requirements of the memory systems, e.g., channel/height/width as opposed to height/width/channel and number of bytes needs. In other words, depending on the architecture of the ML hardware and/or based on the type of data, one or more of the data layout, the mapping of data, the shape of the data (e.g., adding zeros to change the shape), the amount of data being transmitted at a given time (also referred to chunking), etc., may be changed in order to improve the data processing by the ML hardware. Changing the mapping of the data, layout of the data, shape of the data, chunking, etc., is often performed by software, which requires an additional write (as described above) and is inefficient because it requires additional step(s) rather than being part of data transmission, thereby wasting valuable resources.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A depicts a system including an ML hardware configured to convert data from one data format to another data format and further configured to perform data manipulation according to one aspect of the present embodiments.

FIG. 1B depicts a system including an ML hardware positioned within a vehicle configured to convert data from one data format to another data format and further configured to perform data manipulation according to one aspect of the present embodiments.

FIG. 1C depicts a system including an ML hardware in association with a vehicle configured to convert data from one data format to another data format and further configured to perform data manipulation according to one aspect of the present embodiments.

FIG. 2A depicts a system including multiple ML hardware modules according to one aspect of the present embodiments.

FIG. 2B depicts a system with one ML hardware with feedback data according to one aspect of the present embodiments.

FIG. 3 depicts a System-on-chip (SOC) system with multiple ML hardware modules in a multiple chiplet configuration according to one aspect of the present embodiments.

FIG. 4 depicts an example of an ML hardware that includes a plurality of processing tiles arranged in a two-dimensional array of a plurality of rows and columns according to one aspect of the present embodiments.

FIG. 5 depicts a flowchart of an example of a process to convert data from one data format to another and/or manipulate the data within an ML hardware according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

As described above, an application may generate data in a data format that is different from the data format that is needed by an ML hardware or an accelerator to perform one or more ML operations, e.g., convolution, GEMM (i.e., matrix matrix multiply), pooling operations (e.g., MaxPool, AveragePool, etc.), SoftMax, ArgMax, TopK, etc. For example, an application may generate data in a floating point (FP) 32 format, but ML hardware may need that data in a different format, e.g., FP16, FP8 (Exponent 4 and 3 bits of Mantissa (E4M3) or Exponent 5 and 2 bits of Mantissa (E5M2)), integer (INT) 8, unsinged int (UINT) 8, Brain FP (BF) 16, etc. Data formats for illustration purposes that should not be construed as limiting the scope of the embodiments include FP32, FP16, INT8, UINT8, FP8 (E4M3), FP8 (E5M2), BF16, Fixed Point (FXP), In-phase Quadrature FP (IQFP), Quadrature (Q) format, etc. It is appreciated that changing the data format from one data format to another data format may change the precision. In some nonlimiting examples, data format conversion may include quantization/dequantization of data. The need to change the data format from one data format to another that is needed by an ML hardware has traditionally been addressed using software.

A need has arisen to perform data format conversion more efficiently, e.g., without having to write the converted data into a memory component that is external to ML hardware prior to its transmission to ML hardware. In one embodiment, the ML hardware receives the data in its original data format and then converts the data from its initial data format to a data format that is needed by ML hardware, thereby eliminating the need to write the converted data into a memory component before it is transmitted to ML hardware. When the conversion is performed by ML hardware itself, the process occurs in-line as the data is being moved (e.g., transmitted to ML hardware) and as it is being transmitted to ML hardware, therefore no extra cost is incurred, the process is accelerated, and performance and resource usage are improved. As such, the need to use software to perform the data format conversion is eliminated, thereby eliminating the need to write the converted data into a memory component (i.e., freeing up valuable resources) before transmitting it to ML hardware.

In many ML operations, for efficient processing the shape or the layout of the data may need to be changed. For example, a kernel size of 3×3 may be used in ML operations and as such the data may be padded with zeros as an example to change the shape (i.e., dimension) to be more efficiently processed by the ML hardware (enables the same kernel size to be used across the input image). As yet another nonlimiting example, the channel/height/width (CHW) format (i.e., data layout) may be changed to width/height/channel (WHC) of data if it can be processed more efficiently by ML hardware. In some instances, data may be required to be mapped based on ML hardware capabilities. For example, ML hardware may need to process the real portions of an IQFP separate from the imaginary portions, thereby requiring the data to be mapped accordingly. Additionally, an application that generates the data for the ML hardware to process may send data in certain byte sizes, e.g., 1 k bytes, but ML hardware may need the data in a different byte size, e.g., 64 bytes, thereby requiring data to broken into chunks accordingly (also referred to as chunking). It is appreciated that changing the shape of the data (e.g., by padding it with zeros, changing the data layout, etc.), remapping the data (e.g., to separate the real from the imaginary portions), chunking data (e.g., dividing data to chunks that can be processed by ML hardware), etc., may be referred to as data manipulation generically. In one nonlimiting example, data manipulation may include data duplication, data scattering, data gathering, etc.

Data manipulation has traditionally been performed by software (external to the ML hardware), thereby causing additional reads/writes to memories and causing increased latency and incurring additional costs. As such, a need has arisen to push at least one or more of data manipulation functionalities that was traditionally being performed by software to be performed by ML hardware itself, resulting in in-line processing, thereby reducing latency and improving use of resources (e.g., eliminating the need to write to memory first before sending the manipulated data to ML hardware).

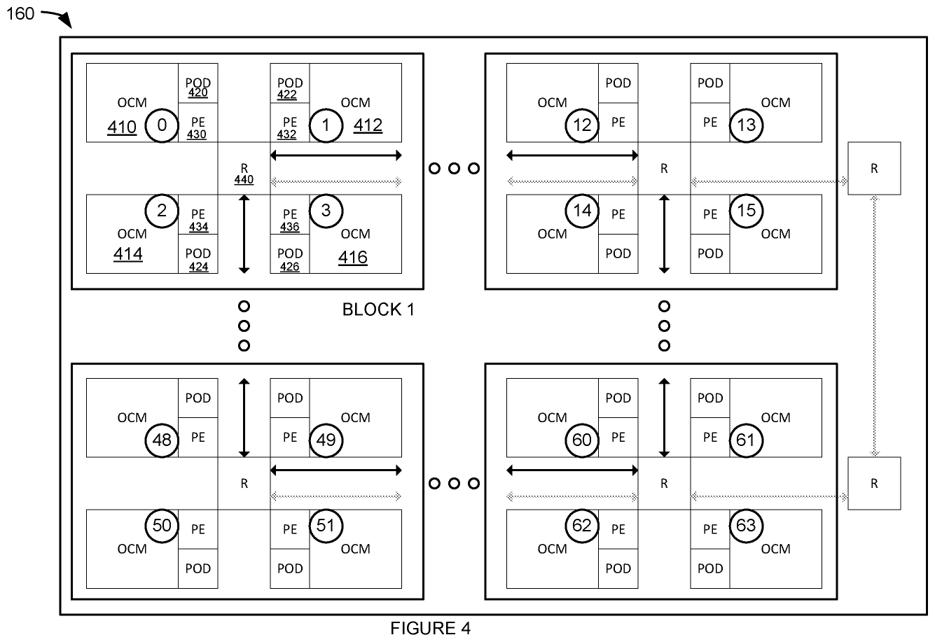

For a non-limiting example, the inference engine (i.e., ML hardware) may include 64 processing elements (each processing element may further include a plurality of smaller processing elements Processing Element (PE) and POD as shown in FIG. 4 and described in the U.S. patent application Ser. No. 17/248,045, filed on Jan. 6, 2021, which is a continuation application of application Ser. No. 16/226,508, filed Dec. 19, 2018, now issued as U.S. Pat. No. 11,086,633, that are incorporated herein by reference in their entirety). Each of those processing elements is configured to receive a sub-vector and an instruction (i.e., compiled SoftMax instructions, ArgMax instruction, etc.). As such, multiple sub-vectors may be operated on simultaneously, thereby reducing the processing time. For illustrative purposes, it is assumed that there are 64 processing elements (also referred to as processing tiles) where each processing element is configured to process 64 elements with a depth of 10 (i.e., 10 vectors). However, it is appreciated that any number of processing tiles, each being capable of processing any number of elements such as 32 as opposed to 64 with a different depth such as 5. In some examples, 4 processing elements may receive a sub-vector (each 32 elements as an example) to process an ArgMax operation on a vector data of size 128 elements in parallel while the other 60 processing elements of the inference engine may operate on a different vector or perform a different ML operation altogether. Accordingly, the index associated with the vector with the largest value can be identified. The architecture of the ML hardware is described in more detail with respect to FIG. 4.

The proposed ML hardware architecture is highly efficient, flexible and optimized for high-efficiency ML computing while programmable to adapt to the changing environment, usage, applications and algorithms for ML with reduced overhead. By providing hardware support to streamline data/instruction flow, the proposed ML hardware architecture improves system-level performance by significantly reducing the hardware overhead involved in moving data and/or instruction in existing computing architectures. Moreover, the programming instruction set reduces the number of instructions required to perform certain tasks, e.g., processing, moving data, loading data, etc. The proposed ML hardware architecture works well with existing software frameworks and code and may be applied to a wide variety of ML algorithms and neural networks including but not limited to convolution neural network (CNN), recurrent neural network (RNN), gradient boosting machine (GBM), generative adversarial neural network, decision trees, random forest, support vector machine (SVM), clustering, Markov random field (MRF), Long Short-Term Memory (LSTM), etc.

The ML hardware according to some embodiments receives data in one format and converts that data format to another data format itself, thereby eliminating the need to write the converted data into a memory component before transmission to ML hardware. Moreover, in some optional embodiments, the ML hardware performs at least one type of data manipulation, e.g., changing the data layout, changing the data shape, data chunking, remapping the data, data duplication, data scattering, data gathering, etc., instead of having software perform those data manipulations before sending it to ML hardware to perform ML operations on. In some embodiments, multiple ML hardware modules may form a chain of ML hardware (e.g., sequentially) where output of one ML hardware is input to another ML hardware and where each ML hardware may perform a particular ML operation or be associated with a particular ML model. It is appreciated that in some embodiments, multiple ML hardware may form a chain of ML hardware where output of one ML hardware may be an input to another ML hardware while the same output may also be an output to an application (e.g., application destination). In other words, an output from one ML hardware may be an input to another ML hardware for processing additional ML operations or ML models while the same output may be the final output and form an input to an application destination. In yet other embodiments, one ML hardware may be used iteratively where the output of the ML hardware forms an input to the same ML hardware for performing additional ML operations or to operate on a different ML model.

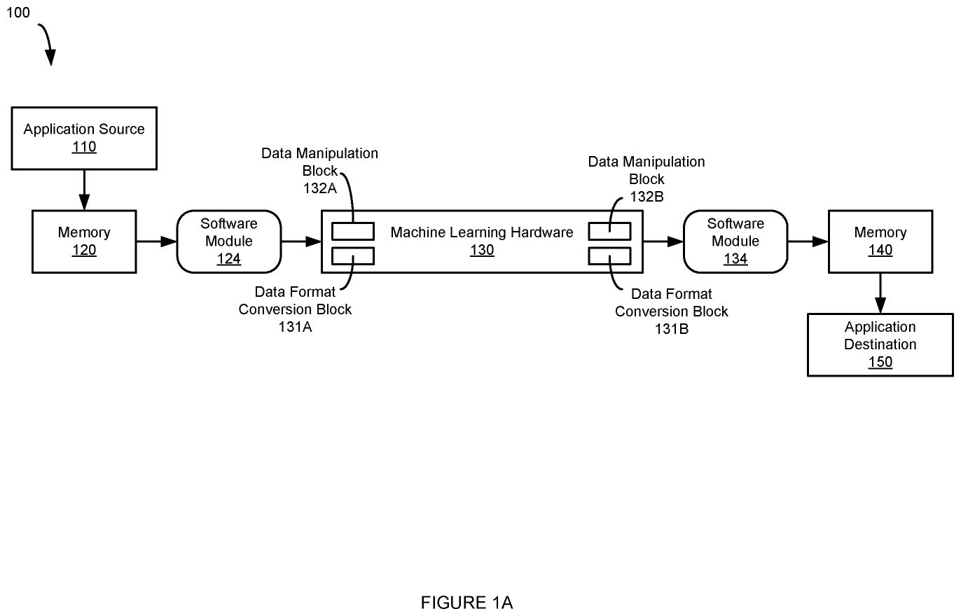

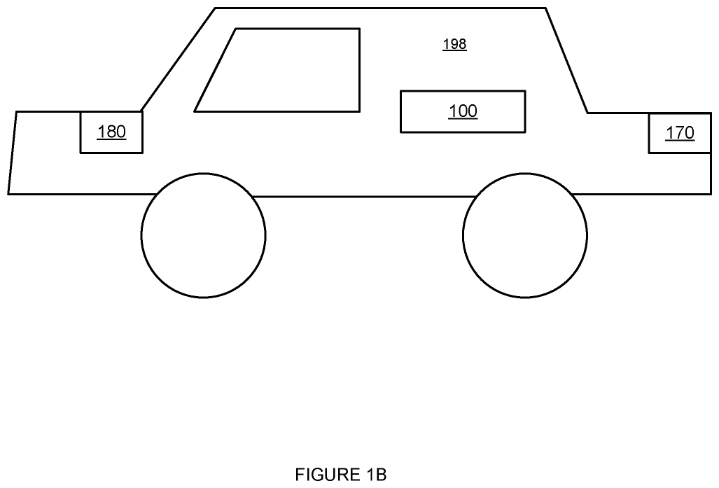

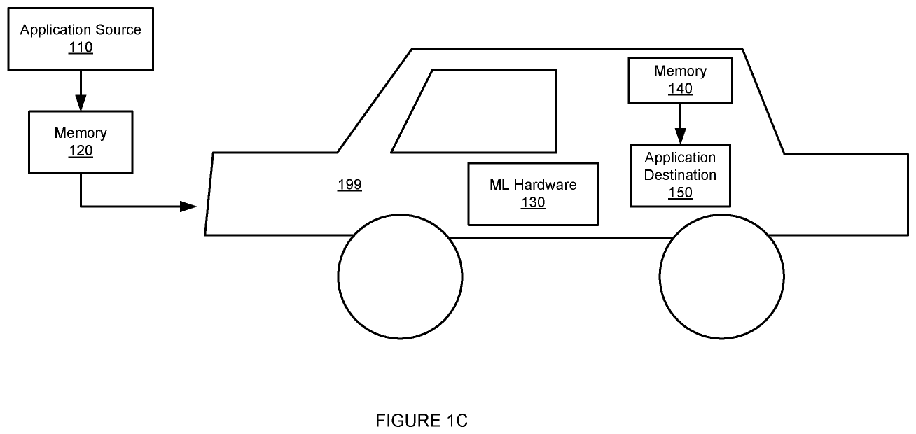

Referring now to FIG. 1A, a system including an ML hardware configured to convert data from one data format to another data format and further configured to perform data manipulation according to some embodiments is shown. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks. It is appreciated that one or more components of the system may run on one or more computing units or devices (not shown) each with software instructions stored in a storage unit such as a non-volatile memory of the computing unit for practicing one or more processes. When the software instructions are executed, at least a subset of the software instructions is loaded into memory by one of the computing units, which becomes a special purposed one for practicing the processes. The processes may also be at least partially embodied in the computing units into which computer program code is loaded and/or executed, such that, the computing units become special purpose computing units for practicing the processes.

The system 100 of FIG. 1A includes an application source 110, a memory component 120, a software module 124, an ML hardware 130, a software module 134, a memory component 140, and an application destination 150. In a nonlimiting example as shown by FIG. 1B for illustrative purposes, the application source 110 may be an application related to a hardware component, e.g., a camera 170, a sensor 180, etc., within a self-driving vehicle 198. It is appreciated that the camera 170, the sensor 180 and the system 100 may be positioned on or within the vehicle 198. In yet another nonlimiting example as shown by FIG. 1C for illustrative purposes, one or more components may be positioned external to the vehicle (discussed later in greater detail), e.g., positioned on the side of the road, and it may be a sensor or a device providing geolocational position or pictures of traffic ahead, as an example. Regardless of the application, the data generated by the application source 110 is ultimately transmitted to the ML hardware 130 (e.g., applying an ML model, performing ML operation, etc.) for fast and efficient processing and the processed data output from the ML hardware 130 is ultimately transmitted to be used by the application destination 150. The application destination 150 may be a sensor, a camera, a processor, a controller, a transmitter/receiver, etc. The application destination 150 may be an application operating on a hardware component either positioned on or within the vehicle 198 or it may be external to the vehicle 199, e.g., positioned on the side of the road. As one nonlimiting example, the application destination 150 may be a controller configured to control the vehicle, e.g., controlling the speed, lane assist, navigation, brake, etc.

In a nonlimiting example, the application source 110 may be an application or a component that generates a set of data in a particular format, e.g., FP32, FP16, INT8, UINT8, FP8 (E4M3 or E5M2), E5M2, BF16, FXP, IQFP, Q format, etc., whereas the ML hardware 130 may need the data in a different data format and/or precision. As a nonlimiting example, the application source 110 may generate data in FP32 format whereas the ML hardware 130 may need the data in FP16 format. The data generated by the application source 110 is initially saved in the memory component 120. It is appreciated that the memory 120 component may be a double data rate (DDR), DDR2, DDR3, DDR4, DDR5, a static random access memory (SRAM), random access memory (RAM), dynamic random access memory (DRAM), solid state drive, hard disk drive, flash memory, etc.

In some embodiments, the data stored in the memory 120 is transmitted to the ML hardware 130 using the software module 124 without converting the data from one data format into another data format. In some embodiments, the software module 124, e.g., firmware, driver, etc., may perform synchronization, scheduling, etc., associated with transmitting the data from the memory 120 to the ML hardware 130 but it does not convert the data from one data format, e.g., FP32, to the needed data format, e.g., FP16. In other words, in contrast to the conventional systems where the data is converted into the data format needed by the ML hardware 130 using software, in the embodiments presented herein, the data conversion from one data format to the needed data format by a data format conversion block 131A of the ML hardware 130. It is appreciated that the data format conversion may be a one step process, e.g., converting from FP32 to INT8 directly, or it may be a multistep process, e.g., converting from FP32 to FP16 to INT8. The data format conversion block 131A may be a hardware component within the ML hardware 130. The need to write the converted data into a memory component before sending the converted data to the ML hardware 130 is eliminated because the data is converted by the data format conversion block 131A of the ML hardware 130 itself resulting in faster processing by eliminating the need for an additional write command. Moreover, latencies and overhead associated with software processing of the conventional system for converting the data from one data format to another format before data is sent to the ML hardware 130 is eliminated because the data is converted to the appropriate data format by the ML hardware 130 itself.

In some embodiments, the ML hardware 130 may process the converted data for various ML operations, e.g., ML model, ML operations, etc. The ML hardware 130 may optionally convert the processed data destined for an application destination 150 to the data format needed by the application destination 150. In one nonlimiting example, the application destination 150 may need the data in INT8 and as such a data format conversion block 131B may perform the conversion of the processed data before it is transmitted out of the ML hardware 130. It is appreciated that the data format conversion block 131B functions similar to that of data format conversion block 131A except that one is processing inbound data and another is processing outbound data. Showing two different data format conversion blocks is for illustrative purposes only and should not be construed as limiting the scope of the embodiments. For example, the data format conversion block 131A may be the same as the data format conversion block 131B but shown separate from another for illustration purposes only. It is further appreciated that the ML hardware 130 may process data in the second data format, e.g., FP16, however, the processed data by the ML hardware 130 may be in a different data format, e.g., INT8. As such, the data format conversion block 131B may receive the processed data not in the second data format, e.g., FP16, but rather in a third data format, e.g., INT8, and converts it to a fourth data format, e.g., FP32 (as expected or needed by the application destination 150).

It is appreciated that the software module 134 may function similar to that of software module 124 except that it receives the data from the ML hardware 130 and stores the data in the memory 140 component destined for the application destination 150. The software module 134 may perform synchronization, scheduling, etc., for the data being transmitted from the ML hardware 130 to the memory 140 component. It is appreciated that if the data format is not converted by the ML hardware 130 then the format conversion may be performed by the software module 134 or even by the application destination 150 itself. In some embodiments, the software module 134 may be the same as that of the software module 124. The memory 140 component may be a double data rate (DDR), DDR2, DDR3, DDR4, DDR5, a static random access memory (SRAM), random access memory (RAM), dynamic random access memory (DRAM), solid state drive, hard disk drive, flash memory, etc. It is appreciated that the data received from the ML hardware 130 is stored in the memory 140 component and ultimately transmitted to the application destination 150. In some nonlimiting examples, the memory 140 component may be an internal memory space within a hardware component where the application destination 150 is running, thereby eliminating the need to use the software module 134 to transmit the data. In other words, the memory 140 component within a device running the application destination 150 may allocate a memory address range where the processed data from ML hardware 130 write the process data to.

It is appreciated that in order to increase efficient processing in many ML operations, the layout or the shape (e.g., dimension of the matrices being processed) of the data may be changed. For example, a kernel size of 3×3 may be used in ML operations and as such the data may be padded with zeros as an example to change the shape (i.e., dimension) to be more efficiently processed by the ML hardware. As yet another nonlimiting example, the channel/height/width (CHW) format of data (i.e., data layout) may be changed to width/height/channel (WHC) if it can be processed more efficiently by ML hardware. Changing the shape or the layout may be performed by a compiler as described in the U.S. application Ser. No. 17/684,871 filed on Mar. 2, 2022, which is incorporated herein by reference in its entirety. The U.S. application Ser. No. 17/684,871 also claims the benefit to a U.S. patent application Ser. No. 17/390,143 filed on Jul. 30, 2021, as well as the U.S. Provisional Patent Application No. 63/230,598 filed on Aug. 6, 2021, which are incorporated herein by reference in their entirety.

Changing the layout of the data as provided above is provided for illustration purposes and should not be construed as limiting the scope of the embodiments. In one nonlimiting example, for a quantized int8 network, each element of the weight matrix is an int8 value that is represented by 1 byte, however, in an fp16 network, 2 bytes per weight elements may be needed, as 2 bytes are needed to represent an fp16 value. In this nonlimiting example, the input of the on-chip memory (OCM) layout for layer 2 tensor may be in CHW format. According to this nonlimiting example, there are 2 channels and the height and width are 5 bytes each. Accordingly, there are 2 blocks of 5×5 data. In this example, the system may require 8 bytes internally for alignment needed by the hardware. Accordingly, the memory layout needed is 5×5 bytes for one channel and another 5×5 bytes for the second channel. In the nonlimiting example, unique names are given for each tensor element (i.e. 1, 2, 11, a1, a11) that is different from the hex values such as a45 to be 2626 in decimal, a number much larger than the range of int8 (i.e. −128 to 127), the data (2 dimensional matrices that is looked at as a single 3 dimensional tensor where the first is representing channel=1 and the second is representing channel=2) may be a matrix

$$[ \begin{matrix}1 & 2 & 3 & 4 & 5 \\ 11 & 12 & 13 & 14 & 15 \\ 21 & 22 & 23 & 24 & 25 \\ 31 & 32 & 33 & 34 & 35 \\ 41 & 42 & 43 & 44 & 45\end{matrix} ]$$

while the data (channel=2 data of the weight tensor) may be a matrix

$$[ \begin{matrix}a 1 & a 2 & a 3 & a 4 & a 5 \\ a 11 & a 12 & a 13 & a 14 & a 15 \\ a 21 & a 22 & a 23 & a 24 & a 25 \\ a 31 & a 32 & a 33 & a 34 & a 35 \\ a 41 & a 42 & a 43 & a 44 & a 45\end{matrix} ] .$$

The memory layout when stored is illustrated below.

| 1 | 2 | 3 | 4 | 5 | x | x | x |
|---|---|---|---|---|---|---|---|
| 11 | 12 | 13 | 14 | 15 | x | x | x |
| 21 | 22 | 23 | 24 | 25 | x | x | x |
| 31 | 32 | 33 | 34 | 35 | x | x | x |
| 41 | 42 | 43 | 44 | 45 | x | x | x |
| a1 | a2 | a3 | a4 | a5 | x | x | x |
| a11 | a12 | a13 | a14 | 815 | x | x | x |
| a21 | a22 | a23 | a24 | a25 | x | x | x |
| a31 | a32 | a33 | a34 | a35 | x | x | x |
| a41 | a42 | a43 | a44 | a45 | x | x | x |

As illustrated, in this nonlimiting example, the system 100 requires 8 bytes internally and since the data is 5 bytes the remainder 3 bytes are illustrated as “x” and used by the system for internal alignment. For illustration purposes, it may have been determined that ML hardware 130 may process the data more efficiently if the data is in HWC format as opposed to CHW. As such, the data may be manipulated to change it from CHW to HWC format. In this example, the height is 5 then it is determined that there are 5 blocks of 5×2 since the width is 5 bytes and the channel is 2. The manipulated data may be stored, e.g., OCM, in ML hardware 130 for ML operation processing. In some nonlimiting examples, the ML hardware 130 may receive a first layer in CHW format and maps it to the processing tiles (described later) and performs the required padding (e.g., shaping data). In some examples, the first layer is received as an input in CHW format and it may be transposed to HWC format (as described above) as part of the flattening process in order to nicely map the convolution into a standard matrix-matrix multiply based on the POD (described later) architecture. In one nonlimiting example, the size of the padding may be 3 and the input is in CHW form for a batch size of 3×224×224. It is appreciated that in some embodiments, no flattening may be needed and as such the transpose might be needed as part of the output of the previous layer or as a separate step in the input layer. In this nonlimiting example, the slicing to map to the tiles is a batch of 8 across 64 tiles, each input is split across 8 tiles and is row-wise (i.e., <35, 35, 35, 35, 35, 35, 35, 19> for tiles <7, . . . , 0>.

In some instances, data may be required to be mapped based on ML hardware capabilities. For example, ML hardware may need to process the real portions of an IQFP separate from the imaginary portions (e.g., in communication systems), thereby requiring the data to be mapped accordingly. Additionally, an application that generates the data for the ML hardware to process may send data in certain byte sizes, e.g., 100 bytes, but ML hardware may need the data in a different byte size, e.g., 8 bytes, thereby requiring data to be broken into chunks accordingly (also referred to as chunking). For example, the application source 110 may generate 100 bytes of data but the ML hardware 130 may need 8 bytes of data at a time therefore requiring the data to be received by the ML hardware 130 to be divided into the appropriate chunks, e.g., 8 bytes. Other types of data manipulation may include data duplication, data scattering, data gathering, etc.

It is appreciated that data manipulation such as changing the shape of the data (e.g., by padding it with zeros, changing the data layout), remapping the data (e.g., to separate the real from the imaginary portions), chunking data (e.g., dividing data to chunks that can be processed by ML hardware), etc., may be performed by the software module 124. However, in some optional embodiments, at least one or more of the data manipulation may be performed by the ML hardware 130 itself, e.g., using a data manipulation block 132A. The data manipulation block 132A may be a hardware component. It is appreciated that performing one or more data manipulation by the data manipulation block 132A results in in-line processing, thereby reducing latency and improving use of resources (e.g., eliminating the need to write to memory first before sending the manipulated data to ML hardware). In other words, performing the data manipulation using the data manipulation block 132A instead of the software module 124 enables the data to be manipulated as part of the transmission process without incurring additional cost. It is appreciated that the data manipulation on the outbound data from the ML hardware 130 may be performed by the software module 134. However, in some optional embodiments, the ML hardware 130 may perform data manipulation on the outbound data from the ML hardware 130, using the data manipulation block 132B. It is appreciated that the data manipulation block 132B functions similar to that of the data manipulation block 132A except that one operates on the inbound data and the other operates on the outbound data. Moreover, it is appreciated that the data manipulation blocks 132A and 132B are shown as two separate components for illustration purposes and should not be construed as limiting the scope of the embodiments. For example, the data manipulation blocks 132A and 132B may be the same block performing one or more data manipulation on inbound and/or outbound data of the ML hardware 130.

Below is an example of a code that illustrates the input, the weight, and the bias constants and output for a fp16 network for illustration purposes. In this nonlimiting example, a convolution layer in a network that is reduced to fp16 precision is illustrated. The structured metadata first describes the tensors involved in this operation in addition to operator specific arguments such as padding and stride information. The total number of multiply and accumulate (MAC) instructions are given. The second part of the structured metadata describes the memory layout of the tensors.

| | |
|---|---|
| Layer 1 : | Conv |
| | Input[1]: float16, [batch, inC, H, W] = [1, 1, 32, 32] |
| | Weight: float16, [outC, inC, H, W] = [64, 1, 3, 3] |
| | Bias: float, [64] |
| | Padding: [top, left, bottom, right] = 0, 0, 0, 0 |
| | Stride: [h, w] = [1, 1] |
| | Activation: relu |
| | output: float16, [batch, H, W, outC] = [1, 30, 30, 64] |
| | # of MACs: 1036800 |
| | # of Parameters: 640 |

//json_annotation:
// code_gen: { io: split_io, wb: dupl_wb },
// mapping_info: {
// batch_size: 1,
// per_batch_num_tiles: 8,
// },
// inputs: [
// { N: 1, inH: 32, inW: 32, inC: 1, inCStride: 1, dataFormat: NCHW, name:
permute_input_0, ddr_addr: 0x36780 }
// ],
// weight: { outC: 64, kH: 3, kW: 3, inC: 1, name: conv2d_kernel_01, ddr_addr:
0x32300, ocm_addr_start: 0x0, ocm_addr_end: 0x7ff },
// bias: { kind: FP32, outC: 64, name: conv2d_bias_0, ddr_addr: 0x32080,
ocm_addr_start: 0x800, ocm_addr_end: 0x8ff },
// outputs: [
// { N: 1, outH: 30, outW: 30, outC: 64, outCStride: 64, name: conv2d_Relu1,
ocm_addr_start: 0xfc380, ocm_addr_end: 0xfffbf }
// ]

Below is yet another example of a code that illustrates quantized network for illustration purposes. In this nonlimiting example, the same convolution layer as in the previous example is shown except that in this example a network is quantized to int8. The structured metadata first describes the tensors involved in this operation in addition to operator specific arguments such as padding and stride information. The total number of MAC instructions are given. The second part of the structured metadata describes the memory layout of the tensors.

| | |
|---|---|
| Layer 1 : | Conv |
| | Input[1]: uint8, [batch, inC, H, W] = [1, 1, 32, 32] |
| | Weight: int8, [outC, inC, H, W] = [64, 1, 3, 3] |
| | Bias: int32, [64] |
| | Padding: [top, left, bottom, right] = 0, 0, 0, 0 |
| | Stride: [h, w] = [1, 1] |
| | Activation: relu |
| | output: uint8, [batch, H, W, outC] = [1, 30, 30, 64] |
| | # of MACs: 1036800 |
| | # of Parameters: 640 |

//INSTRUMENTATION_BEGIN
//json_annotation: {
// code_gen: { io: split_io, wb: dupl_wb },
// mapping_info: {
// batch_size: 1,
// per_batch_num_tiles: 8,
// },
// inputs: [
// { N: 1, inH: 32, inW: 32, inC: 1, inCStride: 1, dataFormat: NCHW, name:
permute_input_0, ddr_addr: 0x1b540 }
// ],
// weight: { outC: 64, kH: 3, kW: 3, inC: 1, name: conv2d_kernel_01, ddr_addr:
0x19300, ocm_addr_start: 0x0, ocm_addr_end: 0xfff },
// bias: { kind: INT32, outC: 64, name: conv2d_bias_0, ddr_addr: 0x19080,
ocm_addr_start: 0x1000, ocm_addr_end: 0x10ff },
// outputs: [
// { N: 1, outH: 30, outW: 30, outC: 64, outCStride: 64, name: conv2d_Relu1,
ocm_addr_start: 0xfe180, ocm_addr_end: 0xfffbf }
// ]

For illustration purposes the ML hardware 130 may be a dedicated hardware including one or more microprocessors and/or on-chip memory (OCM) units storing the data and/or the set of low-level instructions compiled from the high-level code by the compiler to perform one or more ML operations, e.g., convolution, GEMM, MaxPool, SoftMax operation, ArgMax operation, TopK operation, scatter-gather operation, etc. At runtime, the ML-specific hardware 130 is configured to retrieve the set of low-level instructions and/or data from the compiler and execute the set of low-level instructions to perform the one or more ML operations according to the set of low-level instructions. For a non-limiting example, the ML-specific hardware 130 can be but is not limited to an inference engine, which is configured to infer and identify a subject via an inference operation from data input according to the ML network model. The ML hardware 130 may include a plurality of processing tiles, e.g., tiles 0, . . . , 63, arranged in a two-dimensional array of a plurality of rows and columns, e.g., 8 row by 8 columns. Each processing tile (e.g., tile 0) includes at least one OCM, a first type of processing unit (POD), and a second type of processing unit (PE). Both types of processing units can execute and be programmed by some of the plurality of low-level instructions received from the compiler. In some embodiments, a plurality of processing tiles forms a processing block and the processing tiles within each processing block are coupled to one another via a routing element. It is appreciated that the ML-specific hardware 130 is provided for illustrative purposes and should not be construed as limiting the scope of the embodiments. Moreover, it is appreciated that the architecture of the ML hardware 130 is described in more detail with respect to FIG. 4.

Here, the high-level code is a software code written through a commonly-used high-level programming language. For a non-limiting example, the high-level functions of the application or ML operation can be a dense and/or regular operation, e.g., a matrix operation such as multiplication, matrix manipulation, tan h, sigmoid, etc. For another non-limiting example, the high-level functions of the application or ML operation can be a sparse or irregular operation, e.g., memory transpose, addition operation, operations on irregular data structures (such as trees, graphs, and priority queues), etc. In some embodiments, the high-level code of the application may include one or more library function calls to an ML library. For a non-limiting example, a library function may be called to perform a matrix-matrix-multiplication of two matrices of given sizes and the ML library returns the set of low-level instructions that are needed to perform this library function, wherein the set of low-level instructions includes one or more of loading data from a memory (e.g., OCM) into registers, executing dot-product, and storing the data back into the memory.

In some embodiments, the set of low-level instructions are in the format of instruction set architecture (ISA) designed for efficient data processing covering, for non-limiting examples, one or more of different addressing modes, native data types, registers, memory architectures, and interrupts. In some embodiments, the ISA is a predominantly asynchronous instruction set, wherein each instruction in the ISA format programs a state-machine, which then runs asynchronously with respect to other state machines. It is appreciated that a series of instructions in the ISA format do not necessarily imply sequential execution. In some embodiments, the ISA provides separate synchronizing instructions to ensure order between instructions where needed. In some embodiments, when being executed on the ML hardware 130, the set of low-level instructions in the ISA format program the ML hardware 130 by one or more of: (i) programming one or more input data streams to the ML hardware 130; (ii) programming one or more operations to be performed on the input data streams; and (iii) programming one or more output data streams from the ML hardware 130.

It is appreciated that the ML hardware 130 may be used for machine learning applications. For non-limiting examples, the neural network can be but is not limited to one of a convolution neural network (CNN), a recurrent neural network (RNN), a gradient boosting machine (GBM), and a generative adversarial neural network. For non-limiting examples, the additional information includes but is not limited to which tasks of the high-level function belong to a specific neural network layer as well as which neural network layer the high-level function belongs to. It is appreciated that the embodiments as described in FIG. 1A and throughout the application are discussed with respect to a single input to the ML hardware and a single output from the ML hardware for illustration purposes only and should not be construed as limiting the embodiments. For example, an ML hardware according to some embodiments may include a single/multiple input(s) and/or single/multiple outputs where each respective input and/or output may go through one or more data format conversion and/or one or more data manipulation, as described above. It is also appreciated that not every input to the ML hardware has the same data format (e.g., ML hardware may receive two input data in FP32 and INT8 format and converts them to FP16 as an example for processing). It is further appreciated that while the ML hardware may perform its operations on its expected data format, e.g., FP16 in this example, the processed data may be in a different data format, e.g., INT8 and UINT8 for two outputs as an example, where the processed data (two output data in INT8 and UINT8 in this example) are converted by the ML hardware into other formats (e.g., FP32 and BF16 as an example) before they are output from the ML hardware.

Referring now to FIG. 1C, the vehicle 199 is shown with system 100 that is in distributed form. As a nonlimiting example, the application source 110 in FIG. 1C may be related to a component providing traffic information (e.g., geolocational position or pictures of traffic ahead), lane assist, toll transmission, camera, sensor, etc., and it may be positioned external to the vehicle 199, which may be a self-driving vehicle. The data generated by the application source 110 may be stored in the memory 120 component, as described above and subsequently transmitted to the vehicle 199. It is appreciated that the software modules described in FIG. 1A have been omitted for brevity but are in fact present to synchronize and schedule data transmission as described above. The ML hardware 130 in this nonlimiting example is positioned within the vehicle 199 and receives the data generated by the application source 110. The ML hardware 130 processes the data after it converts the data format from its original format to the format needed by the ML hardware 130. The processed data may then be optionally converted to a format needed by the application destination 150 running on a hardware component (e.g., sensor, camera, controller to control the speed of the vehicle or the brake of the vehicle, etc.) and stored in the memory 140 component, as described above. It is appreciated that in one nonlimiting example, the ML hardware 130 may perform no data format conversion for outbound data. Once the data is stored in the memory 140 component, it becomes accessible for use by the application destination 150, as described above.

As described one or more components of the system 100 may be positioned within a vehicle, on the vehicle, or external to the vehicle. As such, particular embodiment showing position of various components within a vehicle or external to the vehicle is for illustrative purposes only and should not be construed as limiting the scope of the embodiments. In other words, the system 100 may be implemented as a distributed system.

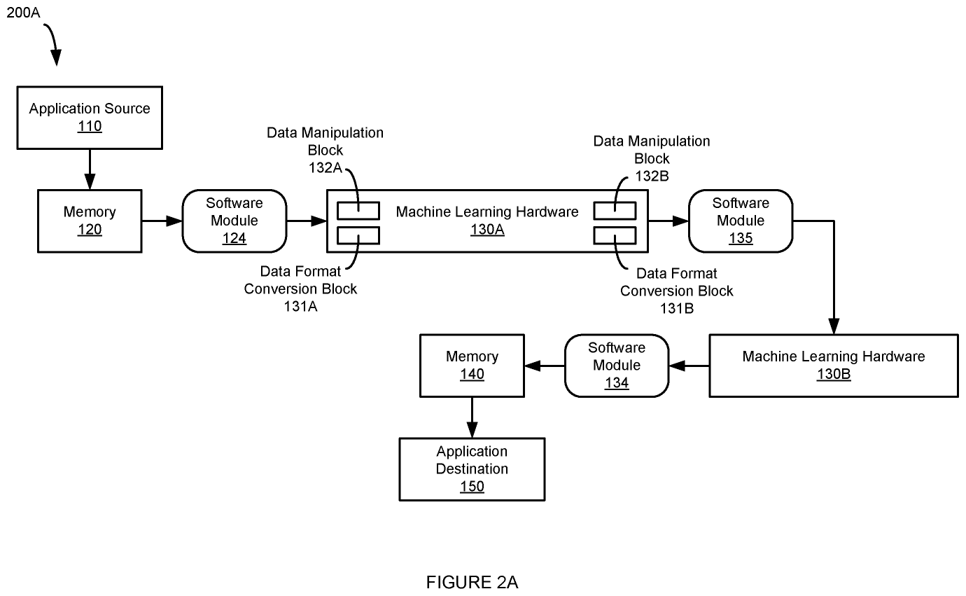

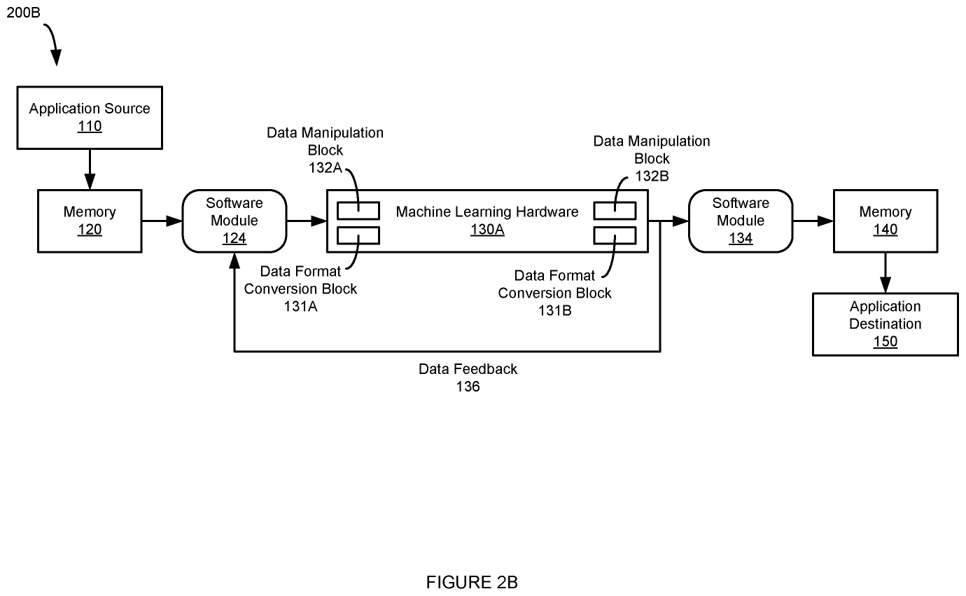

Referring now to FIG. 2A, a system 200A including multiple ML hardware modules according to some embodiments is shown. ML hardware 130A and 130B operate substantially similar to that of ML hardware 130. In this nonlimiting example, the output from the first ML hardware module 130A is output to a software module 135 that operates substantially similar to that of software module 134. In this nonlimiting example, the software module 135 performs data synchronization, scheduling, etc., and may be a driver or a firmware in order to send the processed data from the ML hardware 130A to a second ML hardware 130B formed in a cascaded chain (e.g., sequentially).

In some embodiments, the ML hardware 130A may perform one or more ML operations for a first model while the ML hardware 130B may perform one or more ML operations for a second model. It is appreciated that the ML hardware 130A may optionally convert data from the output data format of the ML hardware 130A to the data format needed by the ML hardware 130B or optionally the ML hardware 130B may convert the data from the output data format of the ML hardware 130A to its required or desired data format. For example, the output data from the ML hardware 130A may be in FP16 format and the ML hardware 130B may need the data to be in INT8 format. As such, appropriate data format conversion is performed by one or more of the ML hardware modules 130A or 130B instead of relying on a software component that was traditionally used. In some nonlimiting examples, the ML hardware 130A may convert the data to an intermediate data format where data is sent in that intermediate data format to ML hardware 130B where it is converted from the intermediate data format to its required data format.

It is appreciated that one or more data manipulation may also be performed on the outbound data from the ML hardware 130A by the ML hardware 130A and/or on the inbound data to the ML hardware 130B by the ML hardware 130B. It is appreciated that ML hardware 130A and ML hardware 130B may be separate hardware components, e.g., two separate chip (i.e., chiplets and sub-processing units) on the same system on chip (SOC). The output data from the ML hardware 130B may similarly be converted to a different data format and/or optionally manipulated by the ML hardware 130B and sent to the software module 134 that is subsequently stored in the memory 140 component for use by the application destination 150. As illustrated, the data may be transmitted between the ML hardware 130A and the ML hardware 130B without having to write to a memory component external to the ML hardware 130A and 130B.

Referring now to FIG. 2B, a system 200B with one ML hardware with feedback data according to some embodiments is shown. FIG. 2B is substantially similar to that of FIG. 1 except that the ML hardware 130A iteratively performs one or more ML operations (e.g., in a feedback loop) where each iteration performs operations related to particular ML model. ML hardware 130A is similar to that of ML hardware 130 except that the ML hardware 130A comprises multiple processing tiles where each processing tile is configured to process one or more ML operations related to a particular ML model and passes the processed data to another iteration for processing one or more ML operations associated with another ML model and the process may continue until the desired data is ML models are processed. In this nonlimiting example, the output of the ML hardware 130A is fed back into the software module 124 to be fed as an input to ML hardware 130A for further processing. The data feedback 136 is transmitted from the output of the ML hardware 130A to the software module 124 for synchronization, scheduling, etc., to be fed into the ML hardware 130A. It is appreciated that the ML hardware 130A may include multiple iterations where each iteration processes a particular ML model or operations associated therewith. For example, the generated data from the application source 110 is transmitted to the ML hardware 130A where it is converted to a data format needed a particular iteration of the ML hardware 130A. It is appreciated that in some optional embodiments, one or more data manipulation may also be performed, as described above. The processed data may then be further manipulated and/or format may be converted and used as data feedback 136 to another iteration of ML hardware 130A for execution of another ML model or operations thereof. It is appreciated that the iterative process may occur any number of times and discussions with respect to one feedback and only two iterations and two ML models is for illustration purposes and should not be construed as limiting the scope of the embodiments.

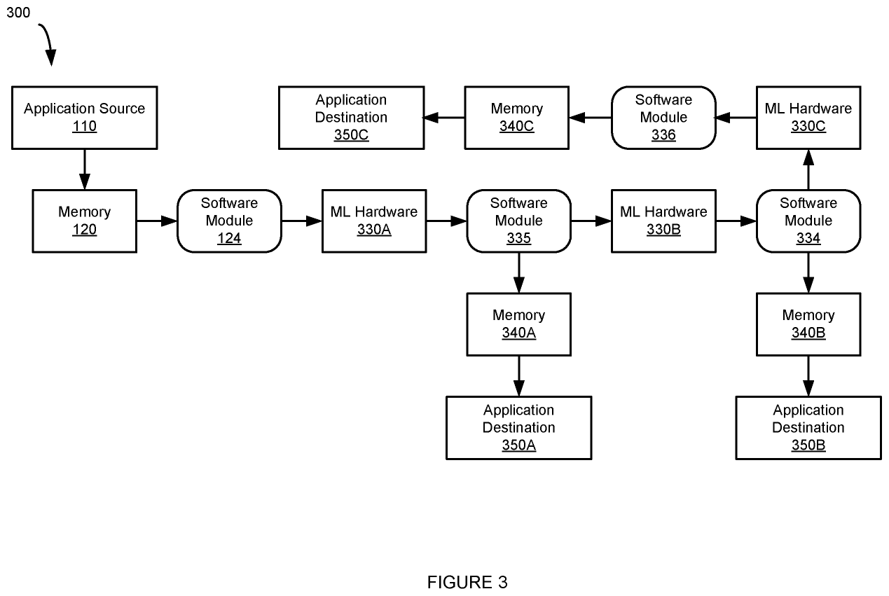

Referring now to FIG. 3, an SOC system 300 with multiple ML hardware modules 330A-C in a multiple chiplets configuration according to some embodiments is shown. The system in this example includes the application source 110 coupled to the memory 120 that is coupled to the software module 124 that transmits the generated data to the ML hardware 330A. ML hardware 330A is substantially similar to ML hardware 130, as described above. The output of the ML hardware 330A may be managed by the software module 335. The software module 335 may be similar to the software module 124 as described above. The software module 335 may store the output from the ML hardware 330A in a memory 340A component to be used by the application destination 150. The memory 340A component and the application destination 350A are similar to the memory 140 component and the application destination 350, as described above. The software module 335 may similarly send the output data from the ML hardware 330A to ML hardware 330B for further processing, e.g., different ML model, different ML operations, etc. It is appreciated that ML hardware 330B functions similar to that of ML hardware 130, as described above. As such, ML hardware 330B may convert the data to the desired data format and/or optionally perform data manipulation, as described above. As such, the output of ML hardware 330A may be used as an input and use by the application destination 350A while it is serves as intermediate data and is provided as an input to another ML hardware 330B.

In some embodiments, the output from the ML hardware 330B may be managed by the software module 334. The software module 334 may be similar to the software module 124 as described above. In some embodiments, the software module 334 may store the output from the ML hardware 330B in a memory 340B component to be used by the application destination 350B. The memory 340B component and the application destination 350B are similar to the memory 140 component and the application destination 150, as described above. The software module 334 may similarly send the output data from the ML hardware 330B to ML hardware 330C for further processing, e.g., different ML model, different ML operations, etc. It is appreciated that ML hardware 330C functions similar to that of ML hardware 130, as described above. As such, ML hardware 330C may convert the data to the desired data format and/or optionally perform data manipulation, as described above. As such, the output of ML hardware 330B may be used as an input and use by the application destination 350B while it is serves as intermediate data and is provided as an input to another ML hardware 330C. The ML hardware 330C processes the data and sends the processed data to the software module 336 that schedules, synchronizes, etc., to store the data in the memory 340C component for use by application destination 350C. It is appreciated that the software module 336 functions similar to that of software module 124, while the memory 340C component operates substantially similar to that of memory 140 component, and while the application destination 350C functions similar to that of application destination 150, as described above.

It is appreciated that the ML hardware modules 330A-330C are shown as separate ML hardware modules (i.e., chiplets) operating as a sub-processing unit of an SOC system for illustration purposes only and should not be construed as limiting the scope of the embodiments. As illustrated, it is appreciated that in some embodiments, multiple ML hardware modules may form a chain of ML hardware where output of one ML hardware may be an input to another ML hardware while the same output may also be an output to an application (e.g., application destination). In other words, an output from one ML hardware may be an input to another ML hardware for processing additional ML operations or ML models while the same output may be the final output and form an input to an application destination. In yet other embodiments, one ML hardware may be used iteratively where the output of the ML hardware forms an input to the same ML hardware for performing additional ML operations or to operate on a different ML model. Furthermore, it is appreciated that the ML hardware modules 330A-330C are described as being substantially similar to one another and to function similar to one another as ML hardware 130 described above for illustrative purposes that should not be construed as limiting the scope of the embodiments. For example, the ML hardware module 330A may be similar to hardware 130 but may be different ML hardware module 330B (with a different configuration such as 8×8 processing tiles or a graphics pipeline unit (GPU), etc.) while they both may perform any data format conversion within their respective module similar to ML hardware 130.

Referring now to FIG. 4, depicts a diagram of an example of the architecture of the ML hardware according to some embodiments. The ML hardware 160 is described in the U.S. patent application Ser. No. 17/248,045, filed on Jan. 6, 2021, which is a continuation application of application Ser. No. 16/226,508, filed Dec. 19, 2018, now issued as U.S. Pat. No. 11,086,633, that are incorporated herein by reference in their entirety. In one nonlimiting example, the inference engine 160 include a plurality of processing tiles, e.g., tiles 0, . . . , 63, arranged in a two-dimensional array of a plurality of rows and columns, e.g., 8 row by 8 columns. Each processing tile (e.g., tile 0) includes at least one OCM, e.g., 410 (or 412, 414, 416), one POD unit, e.g., 420 (or 422, 424, 426), and one processing engine/element (PE), e.g., 430 (or 432, 434, 436). Here, the OCMs in the processing tiles are configured to receive data from the data streaming engine in a streaming fashion. The OCMs, e.g., SRAM, enable efficient local access to data per processing tile. The processing units, e.g., the PODs and the PEs are configured to perform highly specialized tasks, e.g., dense and sparse computations of a ML operation on the received data in the OCMs, respectively. Both the PODs and the PEs can be programmed according to the programming instructions received from the instruction-streaming engine. The architecture and description of the PODs and PEs are described in the U.S. patent application Ser. No. 17/248,045, filed on Jan. 6, 2021, which is a continuation application of application Ser. No. 16/226,508, filed Dec. 19, 2018, now issued as U.S. Pat. No. 11,086,633, that are incorporated herein by reference in their entirety. The data is received and processed by each processing tile as an input data stream and the result is output by each processing tile as a stream of data, thereby reducing the number of instructions required to perform the ML operation substantially. In one non-limiting example, one streaming load instruction replaces thousands of conventionally load instructions. Similarly, one streaming add instruction replaces thousands of conventionally add instructions, and one streaming store instruction replaces thousands of conventionally store instructions.

In some embodiments, a plurality of processing tiles forms a processing block, e.g., tiles 0-3 forms processing block 1 and the processing tiles within each processing block are coupled to one another via a routing element, e.g., tiles 0-3 are coupled to one another via routing element 440 to form processing block 1. It is appreciated that the processing blocks may be coupled to one another in the same row or column via a plurality of routing elements. For the example as shown, there are four processing blocks in each row and column of the two-dimensional array. It is further appreciated that the number and/or types of components within each processing tile, the formation of the processing blocks, the number of processing tiles in each processing block, and the number of processing blocks in each row and column of the ML hardware 160 as shown are exemplary and should not be construed as limiting the scope of the embodiments. In some embodiments, the same number of PE and POD may be used for each tile, and the same number of blocks may be used in each row and column in order to provide flexibility and scalability.

In some embodiments, the OCM in each processing tile may include a number of memory blocks of any size each having one or more read and write ports (not shown). Each OCM block may further include a read queue and a write queue, which buffer the read and write requests of data stored in the OCM, respectively. In some embodiments, the OCMs of processing tiles in the same processing block support aligned-reads, wherein data allocated and maintained in these OCMs can be retrieved directly to the corresponding PODs or PEs in the tiles via at least one read port in each of the OCMs aligned with the corresponding input lanes in the PODs or PEs. Such aligned-reads reduces data swizzles for ML operations, e.g., common matrix multiply operations, on data distributed across multiple processing tiles to reduce both the power and the latency of reading data into the PODs or PEs. Here the data to be read needs to be allocated in the OCMs is such a way that aligned-reads work, e.g., the data may be allocated by breaking down its address (X bits) into POD/PE no. (X-Y bits) and OCM address (Y bits). It is appreciated that the specific implementation discussed is for illustration purposes only and should not be construed as limiting the scope of the embodiments.

In some embodiments, a host running an application source (as described above) may be coupled to a memory, e.g., DDR, and a core engine. The memory may be coupled to a data streaming engine. The core is coupled to an instruction-streaming engine, which is coupled to the data streaming engine. The core may also be coupled to a general processor. In some embodiments, the general processor can be part of the core. The instruction-streaming engine and the data streaming engine are coupled to the dense operation engine and irregular operation engine. In some embodiments, the dense operation engine and the irregular operation engine are part of the ML hardware 160 discussed below. Each of the engines may be a dedicated hardware block/component including one or more microprocessors and on-chip memory units storing software instructions programmed by a user for various machine learning operations. When the software instructions are executed by the microprocessors, each of the hardware components becomes a special purposed hardware component for practicing certain machine learning functions as discussed in detail below. In some embodiments, the architecture is on a single chip, e.g., a system-on-chip (SOC).

The dense operation engine is an engine that is optimized to efficiently process dense data with regular operations, e.g., matrix operations such as multiplication, matrix manipulation, tan h, sigmoid, etc. On the other hand, the irregular operation engine is an engine that is optimized to efficiently process sporadic data with irregular operations, e.g., memory transpose, addition operation, operations on irregular data structures (such as trees, graphs, and priority queues). According to some embodiments, the core may coordinate some of the instructions received from the host to be processed by the general processor, e.g., a CPU, etc.

In one nonlimiting example, the host is a processing unit configured to receive or generate data to be analyzed and/or inferred via machine learning. For a non-limiting example, the host is configured to receive an image, wherein the subject of the image, e.g., a house, a dog, a cat, etc., is to be identified by the ML operation through inference. It is appreciated that while the embodiments are described with respect to identifying the subject matter in the image, the embodiments are not limited thereto, and the data received by the host can be of any type. In some embodiments, the host may also include and provide training data that may be used by the ML hardware 160 for the ML operation to identify the subject in the image, wherein the training data may optionally include a polynomial with their respective weights. In some embodiments, the ML hardware 160 includes the dense operation engine and irregular operation engine. In some embodiments, the host is configured to transmit and save the data to be inferred and/or the training data to the memory. In some embodiments, the host is configured to provide a plurality of commands to the core to coordinate various components in the architecture to perform a ML operation on the data. For a non-limiting example, the memory may receive the data to be inferred and/or the training data from a networking component, e.g., network interface card (NIC), via a direct memory access engine (DMA) per a load command from the host. In some embodiments, the host is configured to communicate with the memory and the core via a PCIe interface/controller.

The core may be a processing engine coupled to the host and configured to receive and interpret a plurality of ML commands for a ML operation from the host. In some embodiments, the core is configured to save the plurality of ML commands in a ML command RAM. It is appreciated that the ML commands may be stored in the memory instead of using ML command RAM. In some embodiments, the ML instruction RAM may be integrated with the NIC thereby reducing extra hops and accelerating access to the memory and/or the ML instruction RAM. Once the ML commands have been interpreted, the core is configured to coordinate activities of other components on the architecture, e.g., the data streaming engine, the instruction-streaming engine, the inference engine, according to the received ML commands. In some embodiments, the core is an FPGA, a CPU, or a microcontroller.

In some embodiments, the core is configured to execute any software code written through a common high-level language. The core is configured to process a plurality of performance non-critical operations, e.g., data/instruction preparatory work, data collection, data mapping, etc. In some embodiments, the core may also be configured to breakdown the received ML commands into performance critical and noncritical operations/tasks such that the performance noncritical operations can be processed by the core and the performance critical operations (e.g., matrix multiplication) can be processed by the ML hardware 160. In other words, the core is configured to divide the plurality of ML commands between the core and the ML hardware 160 for efficient execution thereof. In some embodiments, the core may also be configured to assign/divide the plurality of ML commands (also referred to as tasks or sub-tasks) to various components, e.g., the ML hardware 160, for processing. In some embodiments, the core is configured to allocate one or more locations in the memory for storing of tasks/commands, the data, result after the data is processed, etc. to be accessed and used by the core or other components, e.g., ML hardware 160, in the architecture. As such, the core and the ML hardware 160 are configured to execute the entire ML algorithms and the operation by themselves instead of having to rely on or require the host to execute certain ML commands or operations. By supporting and executing the entire ML operation on the programmable hardware architecture, the core eliminates performance overhead of transferring data to the host and back to execute any non-supported ML operations and reduces burden on the host to achieve a higher performance.

The ML commands and relevant data thereof to be executed by the ML hardware 160 is transmitted from the core and the memory to the instruction-streaming engine and the data streaming engine for efficient streaming to the ML hardware 160. The data/instruction steaming engines are configured to send one or more data streams and programming instructions to the ML hardware 160 in response to the received ML commands from the core. In some embodiments, the core is configured to execute one or more library function calls. For a non-limiting example, a library function call used by the core may be a load command having various parameters, wherein the core may pass certain parameters to the instruction-streaming engine via the library function call. Passing of instructions and their associated data from the core and the memory to the ML hardware 160 via a function call enables different processors with different instruction set architectures to be programmed using a single type of instruction set architecture. In other words, for core the operation being performed is a write operation into a special memory location, i.e., instruction-streaming engine, but in reality the operation being done is passing on specific instructions along with their associated data to the streaming engines, via a function call, for transmission to the ML hardware 160 where they can be executed and processed. Accordingly, the function call provides a mechanism to seamlessly merge more than one instruction set architecture using a single instruction set architecture by encapsulating the instruction within the function call and providing the instruction as data to the special memory location, i.e., instruction-streaming engine, ML hardware 160, etc., where it can be processed. The ML hardware 160 is configured to process the data/instruction streams received from the data/instruction stream engines for the ML operation according to the programming instructions received.

In some embodiments, the instruction-streaming engine is configured to use the parameters provided by the core, via a function call, to stream the ML commands in a specific instruction set architecture format of the ML hardware 160. Similarly, the data streaming engine is configured to fetch the data stored in the memory based on the parameters provided by the core, via a function call, to stream the data in a specific instruction set architecture format of the ML hardware. It is appreciated that the ML commands in the specific instruction set architecture format and the data are streamed in such a way to reduce the number of required operations. For a non-limiting example, a conventional CPU may require a load, process, and store in order to move one piece of data from one location to the next, however, in some embodiments a streaming mechanism may be used such that data and/or instructions are streamed in a continuous fashion without a need to execute three instructions for each piece of data. For a non-limiting example, the received parameters may be used by the instruction-streaming engine to configure the data streaming engine to achieve the streaming load instruction. For another non-limiting example, the instruction-streaming engine may configure the ML hardware 160 to process data in a highly specific and efficient manner based on the received parameters. Specifically, the instruction-streaming engine may configure one or more processing elements within the ML hardware 160 to process the stream of data in a specific manner. In some embodiments, the instruction-streaming engine may also configure on-chip memory on the ML hardware 160 to receive data in a specific manner (e.g., streaming fashion) from the data streaming engine as described below.

In some embodiments, the core is configured to break down a top-level task, e.g., a ML operation, specified by the command from the host into a plurality of sub-tasks and instruct or program other components/blocks on the architecture, e.g., the data streaming engine, the instruction-streaming engine, the ML hardware 160, to execute those sub-tasks in a coordinated fashion. In some embodiments, the core processes performance non-critical operations. Other instructions that are performance critical operations are passed in a function call from the core to the data streaming engine and/or the instruction-streaming engine. Programmer having knowledge of the ML hardware 160 architecture, can pass the performance critical operations to the ML hardware 160. The sub-tasks and their associated data may therefore be streamed, using the instruction-streaming engine and the data streaming engine, to the ML hardware 160, thereby programming the ML hardware 160, as desired. In some embodiments, dense and more regular operations, e.g., matrix operations such as multiplication, matrix manipulation, tan h, sigmoid, etc., may be programmed in a first type of processing unit of the ML hardware 160 while irregular operations, e.g., memory transpose, addition operation, operations on irregular data structures (such as trees, graphs, and priority queues), etc., may be programmed in a second type of processing unit of the ML hardware 160. Hybrid approaches may also be programmed in various types of processing units.

Once programmed, these components/blocks within the ML hardware 160 are responsible for executing the sub-tasks and thus save considerable amount of time and load from the host. It is appreciated that, once the command is broken down to the sub-tasks, certain sub-tasks are being executed by the core itself but commands for other sub-tasks that are highly specialized and require high performance efficiency are transmitted to the instruction-streaming engine, in a function call. In some embodiments, commands for other sub-tasks that are highly specialized may have a different instruction set architecture and appear to the core as data being written to a special memory location but in reality the special memory component is the instruction-streaming engine. The instruction-streaming engine may use the instructions received with the different instruction set architecture with, for non-limiting examples, one or more of different addressing modes, different instructions, different native data types, different registers, different memory architecture, different interrupts, etc., to stream the sub-tasks and any data associated therewith to the ML hardware 160 for execution and further processing. It is further appreciated that the core may generate certain sub-tasks that occur at a frequency less than every cycle for certain components of the architecture, thereby allowing such components to run at a lower frequency than the rest of the architecture, if needed. In some embodiments, any sub-task or programming instructions that are infrequent are executed by the core while repetitive and more frequent programming instructions are executed by a dedicated component of the architecture, e.g., ML hardware 160. The following is an exemplary software code where every sub-task prior to the “LoadAregfromMainMem” is executed by the core and everything after is executed by the ML hardware 160.

```
uint8 weightMat [96] [384] ;
uint weight_r = 96, weight_c = actT_c = 384;
uint9 *actMatT_ptr[64]; //pointers to transposed activation matrix per
OCM POD
uint actT_r[64] = [55x7, 55x7, 55x7, 55x7, 55x7, 55x8, 55x7, 55x5, ... 8
times]
uint9 *bias_ptr[64]; //pointer to bias array in each OCM POD
uint9 *resultMatT_ptr[64]; //pointers to transposed result matrix per
OCM POD
MatrixMultiplyAddBias (weightMat, weight_r, weight_c, actMatT_ptr,
actT_r, actT_c, bias_ptr, resultMatT_ptr, doRelu, doTanhSigmoid)
{
  int mat1_blk_r = 8, linelen = 64, mat2T_blk_r = 32;
  int num_blks = weight_c/linelen // # blks of columns = 384/64 =
6
  /* converting global address pointer to local OCM pointer by
removing the
    higher bits specifying the POD */
  uint9 * actMatTpod_p = (*actMatT_ptr) [0] & 0x3ffff;
  uint9 * biaspod_p = (*bias_ptr) [0] & 0x3ffff;
  uint9 * resMatTpod_p = (*resultMatT_ptr) [0] & 0x3ffff;
  Create_PODgroups_and_PODmask_with_same_number_of_rows (actT_r);
      /* Generates num_groups
            group_blks[ ] - # of 32 row blocks per POD in
each group
            group_remainder[ ] - remainder rows per POD in
each group
            grouppodmask[ ] - mask identifying PODs in
each group
            MaxBlks - Max number of blocks among all
groups
      * /
  for (int i = 0; i < weight_r; i += mat1_blk_r) {
        /* loading 8x384 weights in blocks of 8x64 */
        LoadAregfromMainMem weightMat [i], /* weight matrix
address* /
              linelen, /* size of each line in blk
*/
              weight_c, /* stride between lines */
              mat1_blk_r, /*num of lines in blk */
              linelen, /* stride between blks*/
              num_blks /*num_blks=384/64=6*/
        PodTaskBcst PODall, 1
          LoadBias biaspod_p[i], mat1_blk_r //Load bias for
mat1_blk_x=8
                chnls in each
POD
```

Traditionally, one load instruction is typically needed to load each chunk of data from a memory. In one nonlimiting example, the memory is configured to maintain and provide the data to be inferred and/or the training data to the data streaming engine, which is configured to load the data onto OCM of the ML hardware 160 in a streaming fashion via a single instruction, thereby reducing the number of instructions needed to load the data. Specifically, the data streaming engine is configured to apply one (instead of multiple) load instruction to load a data stream received from the memory by specifying the manner in which the data is to be loaded and the address of the memory, etc. Here, the streaming load instruction may specify one or more of the starting address and the pattern (e.g., the length, the stride, the counts, etc.) of the data to be loaded, thereby eliminating the need for one load instruction for each section/chunk of data.

As presented above, PEs and PODs may be programmed, as desired. The core may be configured to program various components, e.g., PODs and PEs, of the ML hardware 160 via a set of programming instructions translated by the translocation engine according to an instruction set architecture (ISA) designed for efficient data processing in the data-path. In some embodiments, the ISA is a predominantly asynchronous instruction set, wherein each instruction in the ISA programs a state-machine, which then runs asynchronously with respect to other state machines. It is appreciated that a series of instructions do not necessarily imply sequential execution. In some embodiments, the ISA provides separate synchronizing instructions to ensure order between instructions where needed.

In some embodiments, the ISA enables programming of each component, e.g., POD or PE, of the ML hardware 160 in three steps: (i) programming one or more input data streams to the component to fetch input data into queues or registers associated with a computing block/operator of the component; (ii) programming the operator to perform the operations to be performed on the input data streams; and (iii) programming one or more output data streams to write the output of the operations into the OCM of the ML hardware 160.

In some embodiments, the ISA includes at least three classes of programming instructions: (i) programming instructions executed by the PODs, (ii) programming instructions executed by the PEs, and (iii) common programming instructions executed before the tasks are dispatched to either the PODs or the PEs. Note that each of the programming instructions can be executed by one or more or all of the PODs and/or PEs at the same time. The following table summarizes an example of a subset of the instruction set architecture used to program the ML hardware 160.

| | Instruction bit assignment | Description |
|---|---|---|
| | DDR-OCM DMA Instructions | |
| 1. | DMA_DDR_to_OCM(8) ddr_addr (36), ocm_addr (22), | Programs DDR to OCM |
| | linelen (8), linestride(14), numlines(10), blkstride(16), | DMA. signed signifies if the |
| | numblks(10), signed (1) | values being transferred |
| | | signed or unsigned. DoD |
| | | sign-extends or zero- |
| | | extends the 8bit to 9bit |
| | | accordingly. FP16 values |
| | | are tagged as unsigned. |
| 2. | DMA_OCM_to_DDR(8) ocm_addr (22), ddr_addr (36), | Programs OCM to DDR |
| | linelen (8), linestride(14), numlines(10), blkstride(16), | DMA. Unlike |
| | numblks(10) | DMA_DDR_to_OCM, this |
| | | instruction does not have |
| | | sign bit, since 9th bit is |
| | | always dropped when |
| | | writing from OCM to DDR. |
| 3. | DMA_DDR_Gather_to_OCM(8) ddr_ptr_arr_addr(36), | Programs DDR to OCM |
| | OCM addr(22), numptrs(8), linelen(8), signed (1) | DMA for gather |
| 4. | DMA_DDR_to_Table_Tanh_Int8(8) ddr_addr(36), | Copy contents of Int8 |
| | numbytes (10) | Tanh/Sigmoid table from |
| | | DDR to Tile. The number of |
| | | bytes need to match the |
| | | number of bytes in the |
| | | table - Currently 128 entries |
| | | 1 byte each. The table |
| | | needs to be 128 B aligned. |
| 5. | DMA_DDR_to_Table_Tanh_FP16 (8) ddr_addr(36), | Copy contents of FP16 |
| | numbytes (10) | Tanh/Sigmoid table from |
| | | DDR to Tile. The number |
| | | of bytes need to match the |
| | | number of bytes in the |
| | | table - Exact table format |
| | | TBD. |
| 6. | DMA_DDR_to_Table_General_FP16(8) ddr_addr(36), | Copy contents of general |
| | numbytes (10) | FP16 table from DDR to |
| | | Tile. The number of bytes |
| | | need to match the number |
| | | of bytes in the table - |
| | | Currently 128 entries, 2 |
| | | bytes each. |
| | Compute POD instructions - Matrix Multiply | |
| 7. | PDLoadAregMM(8) addr(22), linelen(6), linestride(14), | Programs OCM to Areg |
| | numlines(4), blkstride(14), numblks(12) | Streamer |
| 8. | PDLoadBregMM(8) addr(22), linelen(6), linestride(14), | Programs OCM to Breg |
| | numlines(5), blkstride(14), numblks(12) | Streamer |
| 9. | PDDotProductMM(8) elemperline(6), numAlines(4), | DotProduct operation in |
| | numBlines(5), numblks(12) | Int8/FP16. For FP16, max |
| | | elemperline is 16 |
| 10. | PDStoreCregMM(8) addr(22), elemperline(4), | Write Creg to OCM. Based |
| | linestride(14), numlines(5), doRelu(1), doTanhSigmoid(2) | on int or FP, requantize to |
| | | Int9 or clip to FP16. |
| | | Optionally do Relu, Tanh, |
| | | Sigmoid before writing. |
| 11. | PDStoreCregMMRaw(8) addr(22), elemperline(4), | Write raw Creg (32 b per |
| | linestride(14), numlines(5) | element) to OCM |
| 12. | PDLoadCregMM(8) addr(22), elemperline(4), | Writes Creg (32 b per |
| | linestride(14), numlines(5) | element) from OCM |
| 13. | PDLoadBiasMM(8) addr(22), numelem(4), reset(1) | Loads Bias into Bias buffer. |
| | | Bias is 32 b (both for Int8 |
| | | and FP16) |
| 14. | PDBcstBiastoCregMM(8) numelem(4), bcstlen (5) | Broadcast Bias into Creg |
| | Compute POD instructions - Element-wise Operations | |
| 15. | PDLoadStreamA(8) addr(22), linelen(6), linestride(14), | Program generic load |
| | numlines(10), blkstride(14), numblks(12) | streamer from OCM. Feeds |
| | | into an ALU unit |
| 16. | PDLoadStreamB(8) addr(22), linelen(6), linestride(14), | Program generic load |
| | numlines(10), blkstride(14), numblks(12) | streamer from OCM. Feeds |
| | | into an ALU unit |
| 17. | PDMult(8) elemperline(6), numlines(22) | Elementwise Mult |
| | | (Int8/FP16). FP16: max |
| | | elemperline is 16. |
| 18. | PDAdd(8) elemperline(6), numlines(22) | Elementwise Add |
| | | (Int8/FP16). FP16: max |
| | | elemperline is 16. |
| 19. | PDMoveB(8) elemperline(6), numlines(22) | Move lines from load |
| | | stream B buffer to store |
| | | stream buffer |
| 20. | PDStoreStream(8) addr(22), elemperline(6), | Programs generic Int8 store |
| | linestride(14), numlines(10), blkstride(14), numblks(12), | streamer into OCM. Reads |
| | doRelu(1), doTanhSigmoid(2), bcstall(1), use | output of an ALU. |
| | TileRange(1), relTileSt(8), re TileEnd(8) | Quantizes (Int8) or clips |
| | | (Fp16) on writeback. |
| | | Performs Relu and |
| | | Tanh/sigmoid optionally. If |
| | | bcstall is set then broadcasts |
| | | to all tiles. If use TileRange |
| | | is set then broadcasts to |
| | | other tiles in range specified |
| | | by relTileSt and relTileEnd. |
| | | Tile range is relative. |
| 21. | PDSync (8) | Sync instruction within task. |
| | | Instruction after PDSync |
| | | will execute after all |
| | | instructions before PDSync |
| | | are executed in the same |
| | | Task |
| | PE instructions | |
| 22. | PELoadStream1(8) addr(22), linelen(4), linestride(14), | Programs streamer1 to read |
| | numlines(10), blkstride(14), numblks (12) | from OCM. |
| 23 | PELoadStream2(8) addr(22), linelen(4), linestride(14), | Programs streamer2 to read |
| | numlines(10), blkstride (14), numblks (12) | from OCM. |
| 24 | PEStoreStream(8) addr(22), linelen(4), linestride(14), | Programs streamer to write |
| | numlines (10), blkstride(14), numblks (12), bcstall(1), | to OCM. If bcstall is set |
| | use TileRange(1), relTileSt(8), relTileEnd(8) | then broadcasts to all tiles. |
| | | If use Tile Range is set then |
| | | broadcasts to other tiles in |
| | | range specified by relTileSt |
| | | and relTileEnd. Tile range |
| | | is relative. |
| 25. | PEMove(8) dest (5), src (5), elemperline(4), extend(1), | Moves from src to dest. |
| | int8orFP16(1), stblk(1), endblk(1), rptcnt(22) | This is the only instruction |
| | | that can read ReadQ and/or |
| | | write writeQ. All other |
| | | instructions will only work |
| | | register to register. |
| | | Src = 0x1E and 0x1F are |
| | | ReadQ1 and ReadQ2. Rest |
| | | are registers. Dest = 0x1F is |
| | | WriteQ. Max elemperline |
| | | for FP16 is 8. The stblk and |
| | | endblk specify if this |
| | | instruction is start and/or |
| | | end of an ALUblock. The |
| | | block is repeated rptcnt |
| | | times. The rptent should be |
| | | such that the number of |
| | | ReadQ1/2 reads and WriteQ |
| | | writes match the |
| | | corresponding writes from |
| | | LoadStreamers and reads |
| | | from StoreStreamer, |
| | | respectively. The rptent is |
| | | only valid if stblk = 1. When |
| | | the bit extend is 0 then the |
| | | numbers are transferred as |
| | | is from ReadQ to Register |
| | | to WriteQ (int9->int9 or |
| | | FP16->FP16). When the bit |
| | | extend is 1 then the numbers |
| | | are extended before writing |
| | | (int9 sign-extended to in32; |
| | | FP16 converted to F32). |
| | | When extend is 1, the dest |
| | | can only be a register. |
| | | Int8orFP16 bit specifies if |
| | | the instruction is Integer or |
| | | FP. |
| 26. | PEMoveOp(8) dest (5), src (5), elemperline(4), | Moves from src to dest. |
| | opmask(5), cond (1), int8orFP16(1), stblk(1), endblk(1), | Opmask specifies the unary |
| | rptcnt(22) | operation to be performed |
| | | before the move: |
| | | none/Tanh/ |
| | | Sigmoid/Quantization/ |
| | | Normalization/etc. This |
| | | instruction is only register |
| | | to register, so Src cannot be |
| | | 0x1E or 0x1F and Dest |
| | | cannot be 0x1F. Max |
| | | elemperline for FP16 is 8. |
| | | The cond bit indicates if the |
| | | instruction is conditional. It |
| | | cond is 1 then the |
| | | instruction uses the |
| | | element-wise conditional |
| | | bits in Conditional register |
| | | to decide which elements |
| | | are operated on and which |
| | | are skipped. For elements |
| | | that are skipped, a 0 is |
| | | written in the dest. The stblk |
| | | and endblk specify if this |
| | | instruction is start and/or |
| | | end of an ALUblock. The |
| | | block is repeated rptent |
| | | times. The rptent is only |
| | | valid if stblk = 1. |
| | | Int8orFP16 bit specifies |
| | | if the instruction is |
| | | Integer or FP. |
| 27. | PEAdd(8) dest (5), src1 (5), src2 (5), elemperline(4), | Adds src1 and src2 and |
| | cond(1), int8orFP16(1), stblk(1), endblk(1), rptcnt(22) | writes dest. Max |
| | | elemperline for FP16 is 8. |
| | | The cond bit indicates if the |
| | | instruction is conditional. It |
| | | cond is 1 then the |
| | | instruction uses the |
| | | element-wise conditional |
| | | bits in Conditional register |
| | | to decide which elements |
| | | are operated on and which |
| | | are skipped. For elements |
| | | that are skipped, a 0 is |
| | | written in the dest. The stblk |
| | | and endblk specify if this |
| | | instruction is start and/or |
| | | end of an ALUblock. The |
| | | block is repeated rptcnt |
| | | times. The rptent is only |
| | | valid if stblk = 1. |
| | | Int8orFP16 bit |
| | | specifies if the instruction |
| | | is Integer or FP. |
| 28. | PESub(8) dest (5), src1 (5), src2 (5), elemperline(4), | Same as Add, except does |
| | cond(1), int8orFP16(1), stblk(1), endblk(1), rptcnt(22) | substract |
| 29. | PEMul(8) dest (5), src1 (5), src2 (5), elemperline(4), | Same as Add, except does |
| | cond(1), int8orFP16(1), stblk(1), endblk(1), rptcnt(22) | multiply |
| 30 | PEAnd(8) dest(5), src1(5), src2(5), elemperline(4), | Bitwise AND of src1 and |
| | cond(1), stblk(1), endblk(1), rptcnt(22) | src2. Integer or FP |
| | | agnostic - works on bits. |
| 31. | PEOr(8) dest(5), src1(5), src2(5), elemperline(4), cond(1), | Bitwise OR of src1 and |
| | stblk(1), endblk(1), rptcnt(22) | src2. Integer or FP |
| | | agnostic - works on bits. |
| 32. | PENot(8) dest(5), src(5), elemperline(4), cond(1), stblk(1), | Bitwise NOT of src. Integer |
| | endblk(1), rptcnt(22) | or FP agnostic - works on |
| | | bits. |
| 33. | PEShl(8) dest(5), src(5), shftcnt(5), elemperline(4), | Shift left Src1 by shftent. |
| | cond(1), stblk(1), endblk(1), rptcnt(22) | The instruction performs a |
| | | bit-wise shift, without |
| | | regard to whether the |
| | | number is Int9 or FP16. The |
| | | shift is contained within the |
| | | element. The bits do not |
| | | shift from one element into |
| | | another. |
| 34. | PEShr(8) dest(5), src(5), shftcnt(5), elemperline(4), | Same as PEShl, except shift |
| | cond(1), stblk(1), endblk(1), rptent(22) | right |
| 35 | PEShufL(8) dest(5), src(5), shufont(2), elementperline(4), | Shuffle elements of Src up |
| | cond(1), stblk(1), endblk(1), rptcnt(22) | to 4 elements to the left. |
| | | This instruction moves |
| | | entire element. The |
| | | condition determines which |
| | | source elements participate |
| | | in the operation. The src |
| | | elements with cond bit = 0 |
| | | are set to zero. |
| 36 | PEShufR(8) dest(5), src(5), shufont(2), | Same as PEShufL, except |
| | elementperline(4),cond (1), stblk(1), endblk(1), rptcnt(22) | shuffling to right. |
| 37. | PEMax(8) dest(5), src1 (5), src2 (5), elemperline(4), | Does elementwise Max |
| | cond(1), int8orFP16(1), stblk(1), endblk(1), rptcnt(22) | between src1 and src2 and |
| | | writes the dest. Int8orFP16 |
| | | specifies whether |
| | | instruction is integer or FP. |
| 38. | PEMaxReduce(8) dest(5), src (5), elemperline(4), cond(1), | Does Max operations on all |
| | Int8orFP16(1), stblk(1), endblk(1), rptcnt(22) | the elements in src and |
| | | writes the dest. The |
| | | condition applies to which |
| | | input elements participate in |
| | | the operation. The output |
| | | always written in the |
| | | element 0 (even if the |
| | | corresponding cond bit is 0) |
| 39. | PEMin(8) dest(5), src1 (5), src2 (5) elemperline(4), | Does elementwise Min |
| | cond(1), int8orFP16(1), stblk(1), endblk(1), rptcnt(22) | between dest and src and |
| | | writes the dest. |
| 40. | PEMinReduce(8) dest(5), src (5), elemperline(4), cond(1), | Does Min operations on all |
| | int8orFP16(1), stblk(1), endblk(1), rptcnt(22) | the elements in src and |
| | | writes the dest. The |
| | | condition applies to which |
| | | input elements participate in |
| | | the operation. The output |
| | | always written in the |
| | | element 0 (even if the |
| | | corresponding cond bit is 0) |
| 41. | PEAddReduce(8) dest(5), src (5), elemperline(4), cond(1), | Adds all elements of src and |
| | int8orFP16(1), stblk(1), endblk(1), rptcnt(22) | writes into dest. The |
| | | condition applies to which |
| | | input elements participate in |
| | | the operation. The output |
| | | always written in the |
| | | element 0 (even if the |
| | | corresponding cond bit is 0) |
| 42. | PEDivideFP16(8) dest(5), src1(5), src2 (5), elemper- | Does src1/src2 and writes |
| | line(4), cond(1), stblk(1), endblk(1), rptcnt(22) | the dest. FP16. Not |
| | | available for Int9. |
| 43. | PELoadRegImm(8) dest(5), Imm(32), elemperline(4), | Load values in a register. |
| | cond(1), stblk(1), endblk(1), rptcnt(22) | Imm values are 32b for both |
| | | Int and FP. |
| 44. | PEEq(8) src1(5), src2(5), elemperline(4), int8orFp16(1), | Performance element-wise |
| | stblk(1), endblk(1), rptcnt(22) | equality comparison of src1 |
| | | and src2 and sets the |
| | | condition register. A bit in |
| | | condition register is 1 if |
| | | corresponding element |
| | | comparison is true, else it is |
| | | 0 |
| 45. | PELt(8) src1(5), src2(5), elemperline(4), int8orFP16(1), | Performance element-wise |
| | stblk(1), endblk(1), rptcnt(22) | less than comparison of src |
| | | 1 and src2 and sets the |
| | | condition register. A bit in |
| | | condition register is 1 if |
| | | corresponding element |
| | | comparison is true, else it is |
| | | 0 |
| 46. | PENotCond(8) stblk(1), endblk(1), rptcnt(22) | Inverses the condition |
| | | register |
| 47. | PESaveCond(8) dest(5), stblk(1), endblk(1), rptcnt(22) | Saves the condition register |
| | | in dest |
| 48. | PERestoreCond(8) src(5), stblk(1), endblk(1), rptcnt(22) | Restores the condition |
| | | register from src |
| 49. | PESync (8) | Sync instruction within task. |
| | | Instruction after PESync |
| | | will execute after all |
| | | instructions before PESync |
| | | are executed in the same |
| | | Task |
| | PE/POD/DOD Common instructions | |
| 50. | Loop(8) numinst(5), arglid(8), arglinc(16), arg2id(8), | Allows grouping next |
| | arg2inc(16), arg3id(8), arg3inc(16), loopcnt(22) | numinst instructions into a |
| | | group that is iterated over. |
| | | Up to three arguments in the |
| | | instructions being looped |
| | | can be incremented per |
| | | iteration based on the |
| | | corresponding increment |
| | | count. argid format |
| | | (8bits) - - inst num (5bits): |
| | | argtype(3bits). argtype can |
| | | be: 000 - no arg; 001 - ddr |
| | | addr; 010 - - ocm addr; |
| | | 011 - destreg; 1xx - reserved. |
| | | if argtype is destreg then the |
| | | corresponding arginc can |
| | | only be 1. |
| 51. | TileLoadQuantScaleConsts (8) Rscale (32), Rshift (6), | Loads the constants needed |
| | Dscale (16), QscaleR(16) | for Requantization (Rscale |
| | | and Rshift), Dequantization |
| | | (Dscale) and Quantization |
| | | (QscaleR). QscaleR is |
| | | recriprocal and will be |
| | | multiplied with the source |
| | | number. Rscale and Rshift |
| | | are Integer values and are |
| | | used both in PE or POD. |
| | | Dscale and QscaleR are |
| | | FP16 values. When used to |
| | | provide Rscale values for |
| | | the element-wise |
| | | operations, the Rscale |
| | | should be within 18bits |
| | | or +/− 2\hat{ }17 int number. |
| | Instruction Streamer Instructions | |
| 52. | PodTaskBcst(8) numinst(5), Int8orFP16(1), tilemask(64), | Allows grouping |
| | syncbits(2), set_tag(5), ins_sync_tag(5), startTilePerfCnt | instructions into task that is |
| | (1), endTilePerfCnt(1), startDODPerfCnt (1), | then broadcasted to a |
| | endDODPerfCnt(1) | collection of Pods as |
| | | specified by the Tilemask. |
| | | syncbits can be 00 - |
| | | NoSync, 01 - localSync, |
| | | 10 - Global Sync, 11 - Inst |
| | | Sync. Int8orFP16 specifies |
| | | if the operations in the POD |
| | | task are to be performed in |
| | | Int8 or FP16 format |
| 53. | PETaskBcst(8) numinst(5), tilemask(64), syncbits(2), | Same as PodTaskBcst, |
| | set_tag(5), ins sync_tag(5), startTilePerfCnt (1), | except (i) the broadcast is to |
| | endTilePerfCnt(1), startDODPerfCnt (1), | the PEs and (ii) there is no |
| | endDODPerfCnt(1) | Int8orFP16 bit. Both Int8 |
| | | and FP16 instructions can |
| | | be mixed in a PE task |
| 54. | DMATaskBest(8) numinst(3), tilemask(64), syncbits(2), | Allows grouping DMA |
| | set_tag(5), ins_sync_tag(5), startTilePerfCnt (1), | instructions into task for the |
| | endTilePerfCnt(1), startDODPerfCnt (1), | DoD. It can have only one |
| | endDODPerfCnt(1) | type of DMA instructions at |
| | | a time: DDRtoOCM, |
| | | OCMtoDDR, |
| | | DDRtoOCMgather. It |
| | | cannot mix the instruction. |
| | | For DDRtoOCM and |
| | | DDRtoOCMgather, the |
| | | tilemask specifies the tiles |
| | | that will receive the DMA |
| | | data. For OCMtoDDR, the |
| | | tilemask can only have 1 bit |
| | | set at a time. |
| 55. | ResetTiles(8) tilemask(64) | Reset all pointers and |
| | | synchronization state in the |
| | | Tiles specified by the |
| | | tilemask. OCM content are |
| | | not impacted. |
| 56. | ResetDOD(8) | Reset pointers in both the |
| | | DOD |
| 57. | INSSync (8) set_tag(5), ins_sync_tag(5) | Global sync instruction |
| | | enforced at instruction |
| | | streamer. Instruction after |
| | | INS_Sync will execute after |
| | | all instructions before |
| | | INS Sync are executed. |

It is appreciated that in some nonlimiting examples, one or more ISA instructions may be used to program the ML hardware or components thereof. For example, an ML hardware may be programmed using an ISA instruction such that the conversion of the data format is known by the component performing the data format conversion. For example, one ISA instruction may include a 4-bit field within the ISA instruction to identify the type of data format conversion. As a nonlimiting example, 0000 may indicate that no data format conversion is needed, 0001 may indicate FP32 to FP16 conversion (for data transmission from DDR to OCM) and vice versa, 0010 may indicate FP32 to INT8 conversion (for data transmission from DDR to OCM) and vice versa, 0011 may indicate FP32 to UINT8 conversion (for data transmission from DDR to OCM) and vice versa, 0100 may indicate FP16 to INT8 conversion (for data transmission from DDR to OCM) and vice versa, 0101 may indicate FP16 to UINT8 conversion (for data transmission from DDR to OCM) and vice versa, 0110 may indicate INT9 to INT8 conversion (for data transmission from DDR to OCM) and vice versa, 0111 may indicate INT9 to UINT8 conversion (for data transmission from DDR to OCM) and vice versa, and 1000-1111 may be reserved.

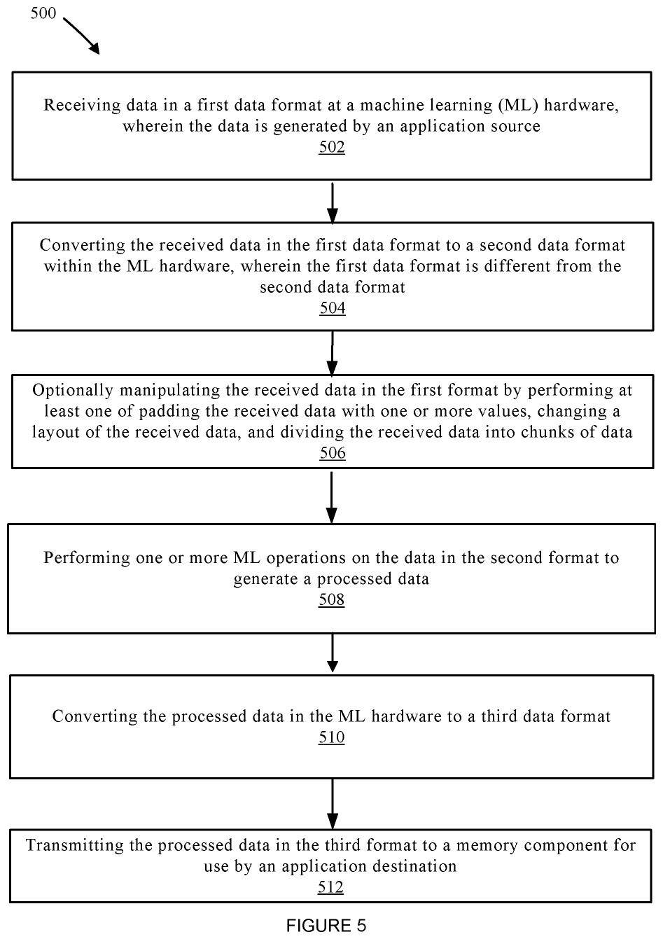

FIG. 5 depicts a flowchart of an example of a process to convert data from one data format to another and/or manipulate data within an ML hardware according to one aspect of the present embodiments. At step 502, data is received in a first data format at a machine learning (ML) hardware. As described above with respect to FIGS. 1A-3, the data is generated by an application source. At step 504, the received data in the first data format is converted to a second data format within the ML hardware, as described in FIGS. 1A-3. It is appreciated that the first data format is different from the second data format. At step 506, the received data is optionally manipulated by performing at least one of padding the received data with one or more values, changing a layout of the received data, and dividing the received data into chunks of data, as described above in FIGS. 1A-3. At step 508, one or more ML operations are performed on the data in the second data format to generate a processed data (the processed data may be in the second data format or a fourth data format), as described above in FIGS. 1A-4. At step 510, the processed data in the ML hardware is converted to a third data format, as described above in FIGS. 1A-3. At step 512, the processed data in the third data format is transmitted to a memory component for use by an application destination, as described in FIGS. 1A-3.

As described above, the embodiments as presented convert data into proper data format for the ML hardware without having to write the converted data into a memory component that is external to ML hardware prior to its transmission to ML hardware. When the conversion is performed by ML hardware itself, the process occurs in-line as the data is being moved (e.g., transmitted to ML hardware) and as it is being transmitted to ML hardware, therefore no extra cost is incurred, the process is accelerated, and performance and resource usage are improved. As such, the need to use software to perform the data format conversion is eliminated, thereby eliminating the need to write the converted data into a memory component (i.e., freeing up valuable resources) before transmitting it to ML hardware. Moreover, pushing one or more data manipulation to be performed by the ML hardware itself results in in-line processing, thereby reducing latency and improving use of resources (e.g., eliminating the need to write to memory first before sending the manipulated data to ML hardware).

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system, comprising:
an application source running on a hardware component configured to generate data in a first data format;
a machine learning (ML) hardware configured to receive the data generated by the application source, wherein the ML hardware is further configured to convert the received data in the first data format to a second data format, and wherein the ML hardware is further configured to perform at least one ML operation on the data in the second data format to generate a processed data, and wherein the ML hardware is further configured to output the processed data; and
an application destination running on another hardware component configured to receive the processed data.

2. The system of claim 1, wherein the processed data is in a third data format, and wherein the ML hardware is further configured to convert the processed data from the third data format to a fourth data format before outputting the processed data.

3. The system of claim 2, wherein the ML hardware comprises a data format conversion block configured to convert the processed data from the third data format to the fourth data format.

4. The system of claim 2, wherein the fourth data format is a data format that the processed data is needed by the application destination.

5. The system of claim 2, wherein the fourth data format is the same as the first data format.

6. The system of claim 2, wherein the third data format is the same as the second data format.

7. The system of claim 1, wherein the first data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

8. The system of claim 1, wherein the first data format is different from the second data format.

9. The system of claim 1, wherein the second data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

10. The system of claim 1, wherein the ML hardware comprises a data format conversion block configured to convert the received data in the first data format to the second data format.

11. The system of claim 1 further comprising a memory component configured to store the generated data in the first data format before transmission to the ML hardware.

12. The system of claim 1, wherein the ML hardware further comprises a data manipulation block configured to manipulate the received data by performing at least one of padding the received data with one or more values, changing a layout of the received data, and dividing the received data into chunks of data.

13. The system of claim 1, wherein the ML hardware further comprises a data manipulation block configured to manipulate the processed data before outputting the processed data, wherein the manipulation of the processed data is at least one of padding the received data with one or more values, changing a layout of the received data, and dividing the received data into chunks of data.

14. The system of claim 1, wherein a software module is configured to schedule data transmission between the application source and the ML hardware without converting the data from one data format to another data format.

15. The system of claim 1, wherein a software module is configured to schedule data transmission between the ML hardware and the application destination without converting the data from one data format to another data format.

16. The system of claim 1, wherein the hardware component is the same as the another hardware component.

17. A machine learning (ML) hardware, comprising:
a first data format conversion block configured to receive data generated by an application source in a first data format, wherein the data format conversion block is configured to convert the received data from the first data format into a second data format, wherein the first data format is different from the second data format;
a plurality of processing units configured to perform one or more ML operations on the data in the second data format to generate a processed data; and
a second data format conversion block configured to convert the processed data to a third data format; and
a transmitting component configured to output the processed data in the third data format to a memory component for use by an application destination.

18. The ML hardware of claim 17, wherein the third data format is a format that the processed data is needed by the application destination.

19. The ML hardware of claim 17, wherein the third data format is the same as the first data format.

20. The ML hardware of claim 17, wherein the first data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

21. The ML hardware of claim 17, wherein the second data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

22. The ML hardware of claim 17 further comprising a data manipulation block configured to manipulate the received data in the first data format by performing at least one of padding the received data with one or more values, changing a layout of the received data, and dividing the received data into chunks of data.

23. The ML hardware of claim 17 further comprising a data manipulation block configured to manipulate the processed data before outputting the processed data, wherein the manipulation of the processed data is at least one of padding the received data with one or more values, changing a layout of the received data, and dividing the received data into chunks of data.

24. The ML hardware of claim 17, wherein the processed data is in a fourth data format.

25. The ML hardware of claim 24, wherein the fourth data format is the same as the second data format.

26. A machine learning (ML) hardware, comprising:
a first data manipulation block configured to receive data generated by an application source in a first data format, wherein the data manipulation block is configured to perform at least one of padding the received data with one or more values, changing a layout of the received data, and dividing the received data into chunks of data;
a plurality of processing units configured to perform one or more ML operations on the data that has been manipulated to generate a processed data in the first data format; and
a second data manipulation block configured to receive the processed data in the first data format, wherein the second data manipulation block is configured to perform at least one of padding the received data with one or more values, changing a layout of the received data, and dividing the received data into chunks of data; and
a transmitting component configured to output the processed data that has been manipulated by the second data manipulation block to a memory component for use by an application destination.

27. The ML hardware of claim 26, wherein the first data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

28. A system, comprising:
a first application source running on a first hardware component configured to generate data in a first data format;
a first machine learning (ML) hardware configured to receive the data generated by the application source, wherein the first ML hardware is further configured to convert the received data in the first data format to a second data format, and wherein the first ML hardware is further configured to perform at least one ML operation on the data in the second data format to generate a first processed data, and wherein the ML hardware is further configured to output the first processed data;
a second ML hardware configured to receive the first processed data originated by the first ML hardware, and wherein the second ML hardware is further configured to convert the first processed data to a third data format if the first processed data is in a format different from the third data format, and wherein the second ML hardware is further configured to perform at least one ML operation on the data in the third data format to generate a second processed data, and wherein the ML hardware is further configured to output the second processed data; and
a first application destination running on a second hardware component configured to receive the second processed data.

29. The system of claim 28, wherein the first ML hardware is further configured to convert the first processed data to the third data format prior to the first processed data being output from the first ML hardware.

30. The system of claim 28, wherein the second ML hardware comprises a data format conversion block configured to convert the second processed data to a fourth data format before the second processed data is output for use by the first application destination.

31. The system of claim 30, wherein the fourth data format is a format that the second processed data is needed by the first application destination.

32. The system of claim 31, wherein the fourth data format is the same as the first data format.

33. The system of claim 28, wherein the first data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

34. The system of claim 28, wherein the first data format is different from the second data format.

35. The system of claim 28, wherein the second data format is different from the third data format.

36. The system of claim 28, wherein the second data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

37. The system of claim 28, wherein the first ML hardware comprises a data format conversion block configured to convert the received data in the first data format to the second data format.

38. The system of claim 28 further comprising a memory component configured to store the generated data in the first data format before transmission to the first ML hardware.

39. The system of claim 28, wherein the first processed data is transmitted from the first ML hardware to the second ML hardware without writing the transmitted data in a memory component external to the first and the second ML hardware.

40. The system of claim 28, wherein the first ML hardware further comprises a data manipulation block configured to manipulate the received data by performing at least one of padding the received data with one or more values, changing a layout of the received data, and dividing the received data into chunks of data.

41. The system of claim 28, wherein the first ML hardware further comprises a data manipulation block configured to manipulate the first processed data before outputting the first processed data, wherein the manipulation of the first processed data is at least one of padding the received data with one or more values, changing a layout of the received data, and dividing the received data into chunks of data.

42. The system of claim 28, wherein a software module is configured to schedule data transmission between the first application source, the first ML hardware, the second ML hardware, and the first application destination without converting the data from one data format to another data format.

43. The system of claim 28, wherein the first hardware component is the same as the second hardware component.

44. The system of claim 28, wherein the first ML hardware is separate from the second ML hardware.

45. The system of claim 28, wherein the first ML hardware and the second ML hardware are different sub-processing units on a same ML hardware, and wherein the first ML hardware is associated with a first ML model and wherein the second ML hardware is associated with a second ML model.

46. The system of claim 28, wherein the first processed data is in a fourth data format and wherein the first ML hardware is configured to convert the first processed data from the fourth data format to a fifth data format before outputting the first processed data to the second ML hardware.

47. The system of claim 46, wherein the fourth data format is different from the second data format.

48. A machine learning (ML) hardware, comprising:
a first data format conversion block configured to receive data generated by an application source in a first data format, wherein the first data format conversion block is configured to convert the received data from the first data format into a second data format, wherein the first data format is different from the second data format;
a first plurality of processing units configured to perform one or more ML operations associated with a first ML model on the data in the second data format to generate a first processed data;
a second data format conversion block configured to convert the first processed data to a third data format;
a second plurality of processing units configured to perform one or more ML operations associated with a second ML model on the first processed data in the third data format to generate a second processed data; and
a transmitting component configured to output the second processed data to a memory component for use by an application destination.

49. The ML hardware of claim 48 further comprising a third data format conversion block configured to receive the second processed data and convert it into a fourth data format prior to transmitting the second data to the memory component.

50. The ML hardware of claim 49, wherein the fourth data format is a format that the processed data is needed by the application destination.

51. The ML hardware of claim 49, wherein the fourth data format is the same as the first data format.

52. The ML hardware of claim 48, wherein the first data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

53. The ML hardware of claim 48, wherein the second data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

54. The ML hardware of claim 48 further comprising a data manipulation block configured to manipulate the received data in the first data format by performing at least one of padding the received data with one or more values, changing a layout of the received data, and dividing the received data into chunks of data.

55. The ML hardware of claim 48, wherein the first processed data is in a fourth data format.

56. The ML hardware of claim 55, wherein the fourth data format is different from the second data format.

57. A method comprising:
receiving data in a first data format at a machine learning (ML) hardware, wherein the data is generated by an application source;
converting the received data in the first data format to a second data format within the ML hardware, wherein the first data format is different from the second data format;
performing one or more ML operations on the data in the second data format to generate a processed data; and
converting the processed data in the ML hardware to a third data format; and
transmitting the processed data in the third data format to a memory component for use by an application destination.

58. The method of claim 57, wherein the third data format is a format that the processed data is needed by the application destination.

59. The method of claim 57, wherein the third data format is the same as the first data format.

60. The method of claim 57, wherein the first data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

61. The method of claim 57, wherein the second data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

62. The method of claim 57 further comprising manipulating the received data in the first data format by performing at least one of padding the received data with one or more values, changing a layout of the received data, and dividing the received data into chunks of data.

63. The method of claim 57, wherein the processed data in the ML hardware is in a fourth data format, and wherein the processed data in the fourth data format is converted to the third data format.

64. A system comprising:
a means for receiving data in a first data format at a machine learning (ML) hardware, wherein the data is generated by an application source;
a means for converting the received data in the first data format to a second data format within the ML hardware, wherein the first data format is different from the second data format;
a means for performing one or more ML operations on the data in the second data format to generate a processed data; and
a means for converting the processed data in the ML hardware to a third data format; and
a means for transmitting the processed data in the third data format to a memory component for use by an application destination.

65. The system of claim 64, wherein the third data format is a format that the processed data is needed by the application destination.

66. The system of claim 64, wherein the third data format is the same as the first data format.

67. The system of claim 64, wherein the first data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

68. The system of claim 64, wherein the second data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

69. The system of claim 64 further comprising a means for manipulating the received data in the first data format by performing at least one of padding the received data with one or more values, changing a layout of the received data, and dividing the received data into chunks of data.

70. The system of claim 64, wherein the processed data in the ML hardware is in a fourth data format, and wherein the processed data in the fourth data format is converted to the third data format.

71. A vehicle, comprising:
a machine learning (ML) hardware configured to receive a data generated by an application source running on a hardware component in a first data format, wherein the ML hardware is further configured to convert the received data in the first data format to a second data format, and wherein the ML hardware is further configured to perform at least one ML operation on the data in the second data format to generate a processed data, and wherein the ML hardware is further configured to output the processed data; and
an application destination running on another hardware component configured to receive the processed data.

72. The vehicle of claim 71, wherein the ML hardware is further configured to convert the processed data from the second data format to a third data format before outputting the processed data.

73. The vehicle of claim 72, wherein the ML hardware comprises a data format conversion block configured to convert the processed data from the second data format to the third data format.

74. The vehicle of claim 72, wherein the third data format is a data format that the processed data is needed by the application destination.

75. The vehicle of claim 72, wherein the third data format is the same as the first data format.

76. The vehicle of claim 71, wherein the first data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

77. The vehicle of claim 71, wherein the first data format is different from the second data format.

78. The vehicle of claim 71, wherein the hardware component is one or more of a sensor, a controller, or a camera.

79. The vehicle of claim 71, wherein the ML hardware comprises a data format conversion block configured to convert the received data in the first data format to the second data format.

80. The vehicle of claim 71 further comprising a memory component configured to store the generated data in the first data format before transmission to the ML hardware.

81. The vehicle of claim 71, wherein the ML hardware further comprises a data manipulation block configured to manipulate the received data by performing at least one of padding the received data with one or more values, changing a layout of the received data, and dividing the received data into chunks of data.

82. The vehicle of claim 71, wherein the ML hardware further comprises a data manipulation block configured to manipulate the processed data before outputting the processed data, wherein the manipulation of the processed data is at least one of padding the received data with one or more values, changing a layout of the received data, and dividing the received data into chunks of data.

83. The vehicle of claim 71, wherein a software module is configured to schedule data transmission between the application source and the ML hardware without converting the data from one data format to another data format.

84. The vehicle of claim 71, wherein a software module is configured to schedule data transmission between the ML hardware and the application destination without converting the data from one data format to another data format.

85. The vehicle of claim 71, wherein the hardware component is the same as the another hardware component.

86. The vehicle of claim 71 further comprising a memory component configured to store the processed data for use by the application destination.

87. The vehicle of claim 71, wherein the processed data is in a third data format, and wherein the processed data in the third data format is converted to a fourth data format by the ML hardware before being output by the ML hardware.

88. The vehicle of claim 87, wherein the third data format is different from the second data format.

89. A method comprising:
generating data in a first data format by an application source;
receiving the data in the first data format at a machine learning (ML) hardware;
converting the received data in the first data format to a second data format within the ML hardware, wherein the first data format is different from the second data format;
performing one or more ML operations on the data in the second data format to generate a processed data; and
converting the processed data in the ML hardware to a third data format; and
transmitting the processed data in the third data format to a memory component for use by an application destination.

90. The method of claim 89, wherein the third data format is a format that the processed data is needed by the application destination.

91. The method of claim 89, wherein the third data format is the same as the first data format.

92. The method of claim 89, wherein the first data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

93. The method of claim 89, wherein the second data format is one of floating point (FP) 32, FP16, integer (INT) 8, unsinged int (UINT) 8, FP8, Brain FP (BF) 16, Fixed Point (FXP), In-phase Quadrature FP (IQFP), and Quadrature (Q) format.

94. The method of claim 89 further comprising manipulating the received data in the first data format by performing at least one of padding the received data with one or more values, changing a layout of the received data, and dividing the received data into chunks of data.

95. The method of claim 89, wherein the processed data is in a fourth data format, and wherein the processed data is converted from the fourth data format to the third data format before being transmitted.

96. A system comprising:
a means for generating data in a first data format by an application source;
a means for receiving the data in the first data format at a machine learning (ML) hardware;
a means for converting the received data in the first data format to a second data format within the ML hardware, wherein the first data format is different from the second data format;
a means for performing one or more ML operations on the data in the second data format to generate a processed data; and
a means for converting the processed data in the ML hardware to a third data format; and
a means for transmitting the processed data in the third data format to a memory component for use by an application destination.
